(19) United States
(12) Patent Application Publication
(10) Pub. No.: US 2019/0365592 A1
(43) Pub. Date: Dec. 5, 2019

(54) MOBILITY ASSISTANCE DEVICE

(71) Applicants: John Mark Norton, Santa Clarita, CA (US); Gregory Thagard, West Hollywood, CA (US)

(72) Inventors: John Mark Norton, Santa Clarita, CA (US); Gregory Thagard, West Hollywood, CA (US)

(21) Appl. No.: 16/431,573

(22) Filed: Jun. 4, 2019

Related U.S. Application Data
(60) Provisional application No. 62/680,542, filed on Jun. 4, 2018.

(51) Int. Cl. A61H 3/04

(52) U.S. Cl. CPC A61H 3/04; A61H 2003/046; A61G 5/04; A61H 2201/5058; A61H 2003/043

(57) ABSTRACT

A mobility assistance device includes a frame having a base frame, a handle frame, and a support frame extending from the base frame to the handle frame. The mobility assistance device also includes a series of wheels coupled to the base frame, at least one electric motor coupled to at least one wheel of the series of wheels, at least one power supply coupled to the at least one electric motor, at least one electronics module coupled to the frame including a memory device and a processor coupled to the memory device, and at least one hand control coupled to the handle frame. Operation of the hand control is configured to control operation of the at least one electric motor.

### CROSS-REFERENCE TO RELATED APPLICATION(S)

The present application claims priority to and the benefit of U.S. Provisional Patent Application No. 62/680,542, filed Jun. 4, 2018, the entire contents of which are incorporated herein by reference.

### BACKGROUND

### 1. Field

The present disclosure relates generally to mobility assistance devices.

### 2. Description of Related Art

Many individuals have mobility challenges, including individuals with birth defects, individuals who have been in an accident, individuals undergoing post-operative physical therapy, and individuals with advanced age. For millions that cannot walk unassisted, the currently available mobility options include wheelchairs, crutches, canes, and walkers. Of the currently available mobility options, only wheelchairs offer the option of a motorized drive. However, wheelchair users do not place any weight or only a small amount of weight on their legs, and therefore wheelchair user may experience muscular atrophy. In contrast, walkers allow the users to put some weight on their legs, which can help prevent muscular atrophy, but walkers do not include the added convenience of motorized drive and thus cannot provide varying levels of assistance based on the mobility needs of the user.

### SUMMARY

The present disclosure is directed to various embodiments of a mobility assistance device. In one embodiment, the mobility assistance device includes a frame having a base frame, a handle frame, and a support frame extending from the base frame to the handle frame. The mobility assistance device also includes a series of wheels coupled to the base frame, at least one electric motor coupled to at least one wheel of the series of wheels, at least one power supply coupled to the at least one electric motor, at least one electronics module coupled to the frame including a memory device and a processor coupled to the memory device, and at least one hand control coupled to the handle frame. Operation of the at least one hand control is configured to control operation of the at least one electric motor.

The at least one hand control may be configured to rotate relative to the handle frame.

The at least one hand control may be configured to slide linearly relative to the handle frame.

The support frame may be collapsible, and the mobility assistance device may be configured to move between a collapsed configuration and a deployed configuration.

The mobility assistance device may also include at least one actuator extending from the base frame to the handle frame. The at least one actuator is configured to move the mobility assistance device between the collapsed configuration and the deployed configuration.

The mobility assistance device may include at least one switch coupled to the handle frame. The at least one switch is configured to activate the at least one actuator.

The mobility assistance device may include a camera and/or a distance sensor coupled to the handle frame.

The mobility assistance device may include instructions stored in the memory device which, when executed by the processor, cause the processor to determine a user profile from an image of a user captured by the at least one camera, and compare the user profile to a baseline reference profile.

The mobility assistance device may include instructions stored in the memory device which, when executed by the processor, cause the processor to determine a position of a user relative to the frame from data collected by the at least one sensor, and compare the position of the user to a predefined spatial envelope defining a maximum acceptable distance and a minimum acceptable distance from the user to the frame.

The instructions, when executed by the processor, may further cause the processor to increase power supplied by the at least one power supply to the at least one electric motor when the position of the user is below the minimum acceptable distance.

The instructions, when executed by the processor, may further cause the processor to decrease power supplied by the at least one power supply to the at least one electric motor when the position of the user is exceeds the maximum acceptable distance.

The mobility assistance device may include an artificial neural network stored in the memory device or a remote memory device accessible by the processor.

The artificial neural network may be configured to identify individuals from images captured by the camera.

The artificial neural network may be configured to autonomously navigate the mobility assistance device based on images captured by the camera and/or data captured by the distance sensor.

The mobility assistance device may include a near-field communication (NFC) receiver configured to receive a signal from an NFC transmitter in a base charging station. The signal enables the mobility assistance device to autonomously navigate to the base charging station.

The mobility assistance device may include a first track extending around a first pair of wheels of the series of wheels, and a second track extending around a second pair of wheels of the series of wheels.

The mobility assistance device may include at least one foot board coupled to the base frame. The at least one foot board is configured to move between a stowed configuration and a deployed configuration.

The mobility assistance device may include at least one appendage support coupled to the base frame. A height of the appendage support relative to the base frame is adjustable.

The mobility assistance device may include a module coupled to the handle frame including a rear-facing light, a speaker, and a microphone.

The mobility assistance device may include a series of pressure sensors in the at least one hand control.

The mobility assistance device may include a series of physical contact point sensors in the at least one hand control. Each of the physical contact point sensors is a piezoelectric sensor or a capacitive touch sensor.

The mobility assistance device may include a portable electronic device coupled to the handle frame. The portable electronic device includes a display, a memory device, a processor, a GPS chip, a cellular chip, and a wireless communications chip. The portable electronic device may be configured to respond to voice commands.

The mobility assistance device may include at least one forward-facing camera coupled to the handle frame. Instructions stored in the memory, when executed by the processor, cause the processor to obtain classifications of objects in images of an environmental scene captured by the forward-facing camera and, when the classifications include at least one hazardous classification, to at least one of cutoff power supply from the at least one power supply to the at least one electric motor, activate at least one brake coupled to one of the plurality of wheels, or provide an alert.

The mobility assistance device may include a haptic feedback device in the at least one hand control, and the alert may include activation of the haptic feedback device.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIGS. 1A-1B are perspective views of a mobility assistance device according to one embodiment of the present disclosure in an upright or deployed configuration and a collapsed or stowed configuration, respectively;

FIG. 2 is a perspective view of a mobility assistance device according to another embodiment of the present disclosure;

FIG. 3A is a perspective view of a mobility assistance device according to a further embodiment of the present disclosure;

FIGS. 3B-3C are perspective views of a user using the embodiment of the mobility assistance device of FIG. 3A;

FIGS. 4A-4D are a front perspective view, a rear detail view, a rear perspective view, and a rear detail view, respectively, of a mobility assistance device according to another embodiment of the present disclosure;

FIGS. 5A-5B are a rear perspective view and a side detail view, respectively, of a mobility assistance device according to another embodiment of the present disclosure;

FIGS. 6A-6D are side perspective views of a mobility assistance device according to one embodiment of the present disclosure;

FIGS. 7A-7B are a side perspective view and a rear perspective view, respectively, of a mobility assistance device according to one embodiment of the present disclosure;

FIG. 8 is a perspective view of a module according to one embodiment of the present disclosure for use with a mobility assistance device; and

FIG. 9 is a schematic electronic block diagram of a mobility assistance device according to one embodiment of the present disclosure.

### DETAILED DESCRIPTION

The present disclosure is directed to various embodiments of a mobility assistance device. According to various embodiments, the mobility assistance device is configured to enable the user to provide some weight on their legs, which can help prevent muscular atrophy, and also provide motorized propulsion to assist the user and provide added mobility.

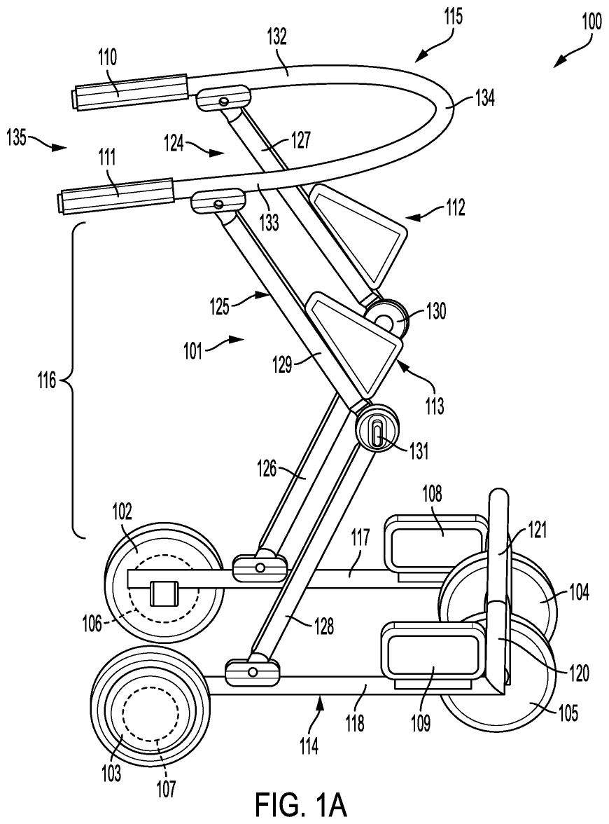

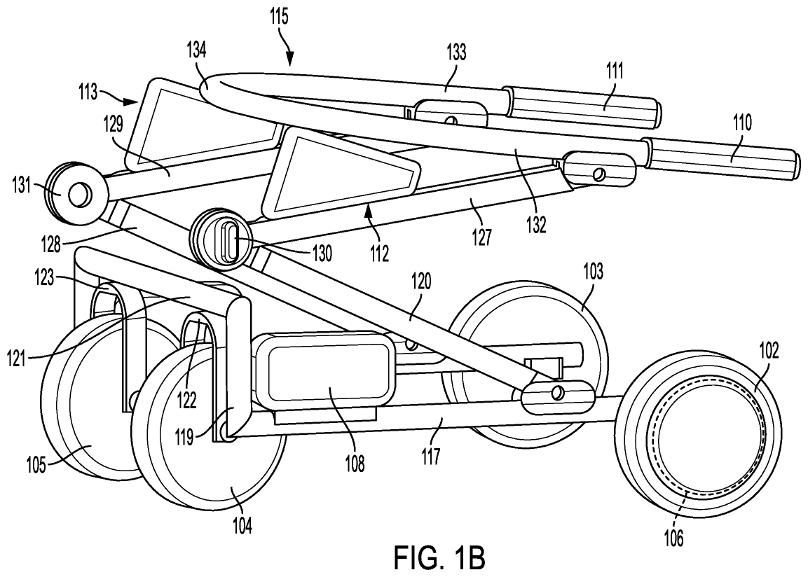

With reference now to FIGS. 1A-1B, a mobility assistance device 100 according to one embodiment of the present disclosure includes a frame 101, a pair of rear wheels 102, 103 coupled to the frame 101, a pair of front wheels 104, 105 coupled to the frame 101, first and second electric motors 106, 107 operably coupled to the rear wheels 102, 103, respectively, first and second power supply modules 108, 109 configured to supply power to the first and second electric motors 106, 107, respectively, hand controls 110, 111 coupled to the frame 101 and configured to control operation of the first and second electric motors 106, 107, respectively, and first and second electronics modules 112, 113 coupled to the frame 101.

In the illustrated embodiment, the frame 101 includes a base frame 114, a handle frame 115, and a collapsible support frame 116 extending from the base frame 114 to the handle frame 115. Additionally, in the illustrated embodiment, the base frame 114 includes a pair of spaced apart longitudinal members 117, 118, a pair of vertical members 119, 120 extending upward from forward ends of the longitudinal members 117, 118, respectively, and a transverse member 121 extending from an upper end of one of the vertical members 119 to an upper end of the other vertical member 120.

In the illustrated embodiment, the rear wheels 102, 103 are coupled proximate to rear ends of the longitudinal members 117, 118, respectively, of the base frame 114. In the illustrated embodiment, the electric motors 106, 107 are provided in rear wheels 102, 103, respectively. In one or more embodiments, the electric motors 106, 107 may be provided outside of the rear wheels 102, 103 and coupled to the rear wheels 102, 103, respectively.

In the illustrated embodiment, the first power supply module 108 is coupled to the first longitudinal member 117 of the base frame 114 and is configured to supply power to the first electric motor 106 that drives the first rear wheel 102, and the second power supply module 109 is coupled to the second longitudinal member 118 of the base frame 114 and is configured to supply power to the second electric motor 107 that drives the second rear wheel 103. In one or more embodiments, the first and second power supply modules 108, 109 may be provided in any other suitable locations (e.g., the power supply modules 108, 109 may be provided in any other suitable locations on the frame 101, such as on the collapsible support frame 116). In one or more embodiments, the power supply modules 108, 109 may include one or more battery cells and/or mega-capacitors.

In the illustrated embodiment, the front wheels 104, 105 are coupled to the transverse member 121 of the base frame 114 with casters 122, 123, respectively. Although in the illustrated embodiment the front wheels 104, 105 are freely turning (e.g., the front wheels 104, 105 are not electromotively driven), in one or more embodiments, the front wheels 104, 105 may be driven by one or more electric motors. Together, the vertical members 119, 120 and the transverse member 121 define a space accommodating the lateral turning of the front wheels 104, 105. Although in the illustrated embodiment the mobility assistance device 100 includes two front wheels 104, 105, in one or more embodiments, the mobility assistance device 100 may include any other suitable number of front wheels, such as a single front wheel.

In the illustrated embodiment, the mobility assistance device 100 is configured to move between a deployed or upright configuration (shown in FIG. 1A) and a collapsed or stowed configuration (shown in FIG. 1B). In the illustrated embodiment, the collapsible support frame 116 includes a pair of braces 124, 125. Additionally, in the illustrated embodiment, the first brace 124 includes a lower segment 126 having a lower end hingedly coupled to the first longitudinal member 117 of the base frame 114, and an upper segment 127 having an upper end hingedly coupled to the handle frame 115. Additionally, in the illustrated embodiment, a lower end of the upper segment 127 is hingedly coupled to an upper end of the lower segment 126. Similarly, in the illustrated embodiment, the second brace 125 includes a lower segment 128 having a lower end hingedly coupled to the second longitudinal member 118 of the base frame 114 and an upper segment 129 having an upper end hingedly coupled to the handle frame 115. A lower end of the upper segment 129 is hingedly coupled to an upper end of the lower segment 128. Each of the braces 124, 125 of the collapsible support frame 116 are configured to move between a collapsed configuration (shown in FIG. 1B) and a deployed configuration (shown in FIG. 1A) corresponding to the collapsed and deployed configurations of the mobility assistance device 100. In the collapsed configuration, the handle frame 115 is proximate to the base frame 114 (e.g., the handle frame 115 is spaced a minimum distance from the base frame 114), and in the deployed configuration, the handle frame 115 is distal to the base frame 114 (e.g., the handle frame 115 is spaced a maximum distance from the base frame 114).

In the illustrated embodiment, the collapsible support frame 116 also includes a pair of locking mechanisms 130, 131. In the illustrated embodiment, the first locking mechanism 130 is provided at the hinge point between the upper and lower segments 126, 127 of the first brace 124, and the second locking mechanism 131 is provided at the hinge point between the upper and lower segments 128, 129 of the second brace 125. The locking mechanisms 130, 131 are configured to enable movement of the collapsible support frame 116 between the collapsed and deployed configurations. For example, in one or more embodiments, when the locking mechanisms 130, 131 are in the locked configuration, the locking mechanisms 130, 131 are configured to prevent the first and second segments 126-129 of each of the first and second braces 124, 125 from rotating relative to each other such that the collapsible support frame 116 is maintained in the deployed configuration shown in FIG. 1A. Additionally, in one or more embodiments, when the locking mechanisms 130, 131 are in the unlocked configuration (e.g., by rotating the knobs), the locking mechanisms 130, 131 are configured to permit the first and second segments 126-129 of each of the first and second braces 124, 125 to rotate relative to each other such that the collapsible support frame 116 may move from the collapsed configuration into the deployed configuration or from the deployed configuration into the collapsed configuration shown in FIG. 1B.

In the illustrated embodiment, the handle frame 115 is generally U-shaped, including a pair of spaced apart longitudinal segments 132, 133 and a rounded portion 134 connecting the longitudinal segments 132, 133 together. In the illustrated embodiment, a closed end of the handle frame 115 defined by the rounded portion 134 is proximate to a front of the mobility assistance device 100, and an open end of the handle frame 115 defined by the pair of spaced apart longitudinal segments 132, 133 is proximate to a rear of the mobility assistance device 100. The handle frame 115 defines an interior space 135 between the longitudinal segments 132, 133 and the rounded portion 134 that is configured to accommodate a user during use of the mobility assistance device.

In the illustrated embodiment, the first hand control 110 is coupled to a rear portion of the first longitudinal segment 132 of the handle frame 115 and the second hand control 111 is coupled to a rear portion of the second longitudinal segment 133 of the handle frame 115. Accordingly, when the user is standing in the interior space 135 of the handle frame 115, the hand controls 110, 111 on the straight longitudinal segments 132, 133 of the handle frame 115 are along the left and right sides of the user. The hand controls 110, 111 are configured to drive and steer (and, optionally, brake) the mobility assistance device 100. In the illustrated embodiment, each of the hand controls 110, 111 is configured to slide linearly (e.g., along a length of the respective longitudinal segment 132, 133 of the handle frame 115) and/or rotate (e.g., rotate about an axial axis of the respective longitudinal segment 132, 133 of the handle frame 115). In one or more embodiments, the forward linear motion of the first hand control 110 is configured to actuate the first electric motor 106 to drive the first rear wheel 102 forward, and the rearward linear motion of the first hand control 110 is configured to actuate the first electric motor 106 in reverse to drive the first rear wheel 102 rearward. Similarly, the forward linear motion of the second hand control 111 is configured to actuate the second electric motor 107 to drive the second rear wheel 103 forward, and the rearward linear motion of the second hand control 111 is configured to actuate the second electric motor 107 in reverse to drive the second rear wheel 103 rearward. In one or more embodiments, the power supplied by the electric motors 106, 107 to the rear wheels, and thus the speed at which the rear wheels 102, 103 are driven, is proportional to the linear displacement and/or the linear force applied to the respective hand controls 110, 111. The hand controls 110, 111 may include any suitable type or kind of sensors configured to detect or measure the linear and/or rotational movement of the hand controls 110, 111 relative to the handle frame 115, and/or detect or measure the linear and/or rotational force applied to the hand controls 110, 111, such as, for example, strain gages and/or displacement sensors.

In the illustrated embodiment, each of the electronics modules 112, 113 includes a memory device, a processor, and a controller. The memory devices are programmed with software instructions which, when executed by the processor, cause the processor to receive the input signals from the hand controls 110, 111 (e.g., displacement or force measurements) and to cause the controller to control the supply of power from the power supply modules 108, 109 to the electric motors 106, 107 in accordance with the signals from the hand controls 110, 111.

In operation, the mobility assistance device 100 may be driven forward by pushing the hand controls 110, 111 forward such that the same or substantially the same forward linear force is applied to each of the hand controls 110, 111 and/or each of the hand controls 110, 111 is displaced with the same or substantially the same forward linear displacement. In one or more embodiments, the speed at which the mobility assistance device 100 is driven forward is proportional to the forward linear force applied to the hand controls 110, 111 and/or the forward linear displacement of the hand controls 110, 111.

Additionally, in operation, the mobility assistance device 100 may be driven rearward by pushing or pulling the hand controls 110, 111 rearward such that the same or substantially the same rearward linear force is applied to each of the hand controls 110, 111 and/or each of the hand controls 110, 111 is displaced with the same or substantially the same rearward linear displacement. In one or more embodiments, the speed at which the mobility assistance device 100 is driven rearward is proportional to the rearward linear force applied to the hand controls 110, 111 and/or the rearward linear displacement of the hand controls 110, 111.

Additionally, in operation, the mobility assistance device 100 may be driven forward with a turn in one direction (e.g., veering to the left or the right) by unequally pushing the hand controls 110, 111 forward such that the forward linear force and/or the forward linear displacement of one hand control is different than the forward linear force and/or the forward linear displacement of the other hand control. In one or more embodiments, the extent (e.g., the angle) at which the mobility assistance device 100 turns is proportional to the difference between the forward linear forces and/or the forward linear displacements of the hand controls 110, 111.

Additionally, in operation, the mobility assistance device 100 may be driven rearward with a turn in one direction (e.g., veering to the left or the right) by unequally pushing or pulling the hand controls 110, 111 rearward such that the rearward linear force and/or the rearward linear displacement of one hand control 110, 111 is different than the rearward linear force and/or the rearward linear displacement of the other hand control 110, 111. In one or more embodiments, the extent (e.g., the angle) at which the mobility assistance device 100 turns is proportional to the difference between the rearward linear forces and/or the rearward linear displacements of the hand controls 110, 111.

Furthermore, in operation, the mobility assistance device 100 may be turned in one direction (e.g., turned left or right without moving forward or backward) by pushing or pulling one of the hand controls 110, 111 forward or rearward and not operating the other hand control 110, 111. In one or more embodiments, the speed at which the mobility assistance device 100 turns is proportional to the rearward or forward linear force applied to one of the hand controls 110, 111 and/or the rearward or forward linear displacement of one of the hand controls 110, 111.

In one or more embodiments, the maximum rearward speed and/or the maximum forward speed of the mobility assistance device 100 may be limited to be below the maximum speeds achievable by the electric motors 106, 107 and the rear wheels 102, 103. For instance, in one or more embodiments, the maximum forward speed of the mobility assistance device 100 may be equal or substantially equal to a maximum forward walking speed of the user (e.g., 1 kph or approximately 1 kph).

Although in the illustrated embodiment the mobility assistance device includes two hand controls 110, 111, in one or more embodiments, the mobility assistance device 100 may include a single hand control. In one or more embodiments, the single hand control is configured to slide linearly (e.g., along a length of one of the longitudinal segment 132, 133 of the handle frame 115) and rotate (e.g., rotate about an axial axis of one of the longitudinal segment 132, 133 of the handle frame 115). In one or more embodiments in which the mobility assistance device 100 includes a single hand control, the forward linear motion of the hand control is configured to actuate both the first and second electric motors 106, 107 to drive the first and second rear wheels 102, 103 forward, the rearward linear motion of the hand control is configured to actuate the first and second electric motors 106, 107 in reverse to drive the first and second rear wheels 102, 103 rearward, and the rotation of the hand control is configured to differentially drive the first and second motors 106, 107 and the first and second rear wheels 102, 103 to steer the mobility assistance device 100. In one or more embodiments, the power supplied by the electric motors 106, 107 to the rear wheels 102, 103, and thus the speed at which the rear wheels 102, 103 are driven, is proportional to the linear force (or linear displacement) and the angular force (angular displacement) applied to the hand control.

Although in the illustrated embodiment the mobility assistance device 100 is configured to steer by differentially driving the first and second motors 106, 107 and the first and second rear wheels 102, 103, in one or more embodiments the mobility assistance device 100 may be configured to steer by changing the angle of one or more of the wheels 102-105 relative to the base frame 114. In one or more embodiments, the mobility assistance device 100 may be configured to steer by a combination of differentially driving the first and second motors 106, 107 and the first and second rear wheels 102, 103 and changing the angle of one or more of the wheels 102-105 relative to the base frame 114.

In one or more embodiments, the user may stop the rearward or forward movement of the mobility assistance device 100 by releasing the hand controls 110, 111 and allowing the mobility assistance device 100 to stop due to, at least in part, the rolling resistance of the wheels 102-105. In one or more embodiments, the mobility assistance device 100 may include brakes coupled to the rear wheels 102, 103. Additionally, in one or more embodiments, the mobility assistance device 100 may include switches configured to disengage the brakes. Accordingly, in one or more embodiments, the mobility assistance device 100 may not be driven unless one or both of the switches are activated (e.g., depressed) by the user. The switches may have any suitable configuration, such as, for instance, paddles or buttons.

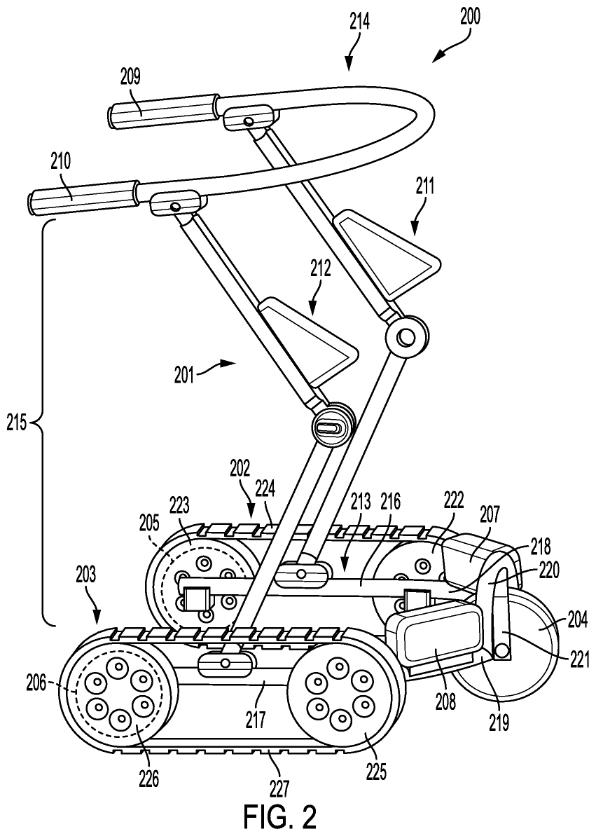

FIG. 2 illustrates a mobility assistance device 200 according to another embodiment of the present disclosure. In the illustrated embodiment, the mobility assistance device 200 includes a frame 201, a pair of track assemblies 202, 203 coupled to opposite sides of the frame 201, a front wheel 204 coupled to the frame 201, first and second electric motors 205, 206 operably coupled to the track assemblies 202, 203, respectively, first and second power supply modules 207, 208 configured to supply power to the first and second electric motors 205, 206, respectively, hand controls 209, 210 coupled to the frame 201 and configured to control operation of the first and second electric motors 205, 206, respectively, and first and second electronics modules 211, 212 coupled to the frame 201. In the illustrated embodiment, the frame 201 includes a base frame 213, a handle frame 214, and a collapsible support frame 215 extending from the base frame 213 to the handle frame 214.

The configuration of the mobility assistance device 200 may be the same as the configuration of the mobility assistance device 100 illustrated in FIGS. 1A-1B, with the exception of the base frame 213, the track assemblies 202, 203 instead of the rear wheels 102, 103, and the single front wheel 204 instead of the pair of front wheels 104, 105. Accordingly, a detailed discussion of the components and features that are common with the embodiment of the mobility assistance device 100 illustrated in FIGS. 1A-1B is omitted for brevity.

In the illustrated embodiment, the base frame 213 includes a pair of spaced apart longitudinal members 216, 217, a pair of angled members 218, 219 extending inward from forward ends of the longitudinal members 216, 217, and a curved member 220 extending upward and connecting inner ends of the angled members 218, 219 together. In the illustrated embodiment, the front wheel 204 is coupled to the curved member 220 with a caster 221 such that the front wheel 204 is freely turning (e.g., not electromotively driven) and the curved member 220 defines a space accommodating the lateral turning of the front wheel 220.

In the illustrated embodiment, the first power supply module 207 is coupled to the first angled member 218 of the base frame 213 and is configured to supply power to the first electric motor 205 that drives the first track assembly 202, and the second power supply module 208 is coupled to the second angled member 219 of the base frame 213 and is configured to supply power to the second electric motor 206 that drives the second track assembly 203. In one or more embodiments, the first and second power supply modules 207, 208 may be provided in any other suitable locations (e.g., the power sources may be provided in any other suitable locations on the frame 201, such as on the collapsible support frame 215).

In the illustrated embodiment, the first track assembly 202 includes a pair of wheels 222, 223 and a track 224 extending around both of the wheels 222, 223. Additionally, in the illustrated embodiment, one of the wheels 222 is coupled to the first longitudinal member 216 proximate to the forward end of the first longitudinal member 216 and the other wheel 223 is coupled to the first longitudinal member 216 proximate to the rearward end of the first longitudinal member 216. Similarly, in the illustrated embodiment, the second track assembly 203 includes a pair of wheels 225, 226 and a track 227 extending around both of the wheels 225, 226. Additionally, in the illustrated embodiment, one of the wheels 225 is coupled to the second longitudinal member 217 proximate to the forward end of the second longitudinal member 217 and the other wheel 226 is coupled to the second longitudinal member 217 proximate to the rearward end of the second longitudinal member 217.

The hand controls 209, 210 are configured to actuate the first and second electric motors 205, 206 and thereby drive the first and second track assemblies 202, 203 in a manner similar to how the hand controls 110, 111 actuate the first and second electric motors 106, 107 and the first and second rear wheels 102, 103 in the embodiment of the mobility assistance device 100 illustrated in FIGS. 1A-1B.

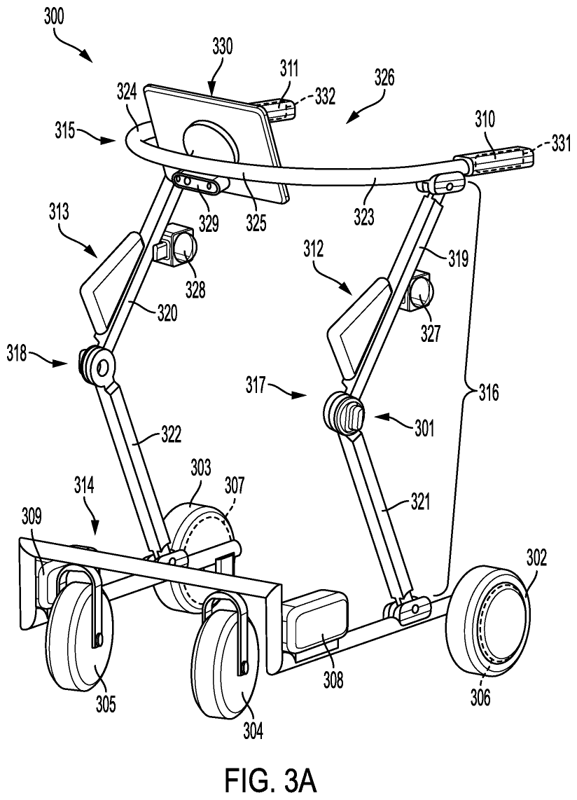

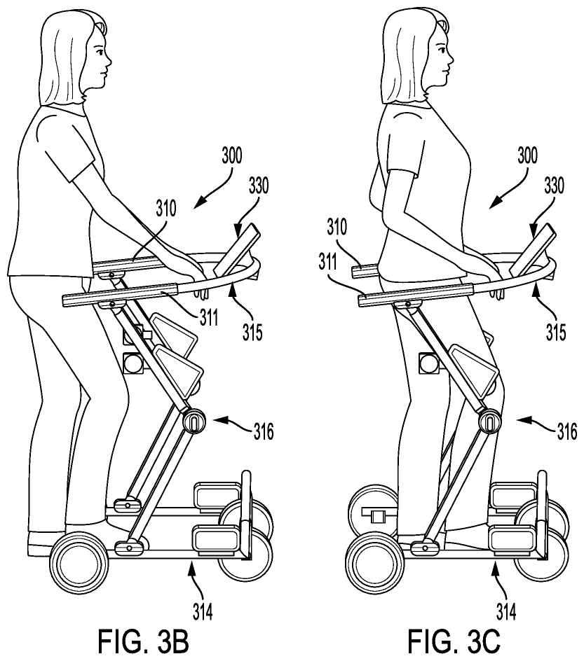

FIG. 3A depicts a mobility assistance device 300 according to another embodiment of the present disclosure. In the illustrated embodiment, the mobility assistance device 300 includes a frame 301, a pair of rear wheels 302, 303 coupled to the frame 301, a pair of front wheels 304, 305 coupled to the frame 301, first and second electric motors 306, 307 operably coupled to the rear wheels 302, 303, respectively, first and second power supply modules 308, 309 configured to supply power to the first and second electric motors 306, 307, respectively, hand controls 310, 311 coupled to the frame 301 and configured to control operation of the first and second electric motors 306, 307, respectively, and first and second electronics modules 312, 313 coupled to the frame 301.

In the illustrated embodiment, the frame 301 includes a base frame 314, a handle frame 315, and a collapsible support frame 316 extending from the base frame 314 to the handle frame 315. Additionally, in the illustrated embodiment, the collapsible support frame 316 includes a pair of braces 317, 318, and each brace 317, 318 includes an upper segment 319, 320 hingedly coupled, at an upper end, to the handle frame 315 and a lower segment 321, 322 hingedly coupled, at a lower end, to the base frame 314 and hingedly coupled, at an upper end, to the upper segment 319, 320, respectively. The collapsible support frame 316 (e.g., the braces 317-320) enable the mobility assistance device 300 to move between a collapsed configuration and a deployed configuration.

In the illustrated embodiment, the handle frame 315 is generally U-shaped, including a pair of spaced apart longitudinal segments 323, 324 and a rounded portion 325 connecting the longitudinal segments 323, 324 together. In the illustrated embodiment, a closed end of the handle frame 315 defined by the rounded portion 325 is proximate to a front of the mobility assistance device 300, and an open end of the handle frame 315 defined by the pair of spaced apart longitudinal segments 323, 324 is proximate to a rear of the mobility assistance device 300. The handle frame 315 defines an interior space 326 between the longitudinal segments 323, 324 and the rounded portion 325 that is configured to accommodate a user during use of the mobility assistance device 300.

The configuration of the mobility assistance device 300 may be the same as the configuration of the mobility assistance device 100 illustrated in FIG. 1, with the exception of a pair of cameras 327, 328, a stereo camera 329 or other suitable distance sensor, and a portable electronic device 330 each coupled to the frame 301. A detailed discussion of the components and features that are common with the embodiment of the mobility assistance device 100 illustrated in FIGS. 1A-1B is omitted for brevity.

In the illustrated embodiment, the cameras 327, 328 are coupled to upper segments 319, 320 of the braces 317, 318, respectively, of the collapsible support frame 316. In one or more embodiments, the cameras 327, 328 may be positioned in any other suitable location on the mobility assistance device 300, such as, for instance, on the handle frame 315. In one or more embodiments, each of the cameras 327, 328 may be a 360° camera. In one or more embodiments, the cameras 327, 328 are configured to monitor the user's body position and/or the user's posture relative to the frame 301 or a portion thereof (e.g., the handle frame 315) of the mobility assistance device 300. Although in the illustrated embodiment the mobility assistance device 300 includes two cameras 327, 328, in one or more embodiments the mobility assistance device 300 may include any other suitable number of cameras for monitoring the position of the user relative to the frame 301 of the mobility assistance device 300. In general, increasing the number of cameras 327, 328 increases the details of the users body (e.g., position, orientation, and/or posture) that may be captured by the cameras 327, 328.

In one or more embodiments, the electronic modules 312, 313 each house a processor and a non-volatile memory device connected to the processor. Additionally, in one or more embodiments, each of the electronic modules 312, 313 may include a wireless communication chip and a network adapter. In one or more embodiments, each of the electronic modules 312, 313 may include a system bus configured through which the electronic components of the electronic module communicate with each other.

In one or more embodiments, the memory devices of the electronics modules 312, 313 include software instructions stored therein which, when executed by the processor, cause the processor to receive one or more images of the user captured by the cameras 327, 328 and determine, from the one or more images of the user, the position of the user relative to the frame 301 or a portion thereof (e.g., the handle frame 315) of the mobility assistance device 300. In one or more embodiments, the software instructions, when executed by the processor, further cause the processor to determine the direction in which the mobility assistance device 300 is moving and/or the speed at which the mobility assistance device 300 is moving (e.g., the software instructions may cause the processor to receive one or more images from the stereo camera 329 to determine a distance from the mobility assistance device 300 to an object, and to integrate the distance over time to determine the speed of the mobility assistance device 300). Additionally, in one or more embodiments, the software instructions, when executed by the processor, cause the processor to determine if the position of the user exceeds a predefined spatial envelope (e.g., a spatial envelope within the interior space 326 defined by the handle frame 315). The predefined spatial envelope defines a maximum acceptable distance from the user to the frame 301 (e.g., the handle frame 315) and a minimum acceptable distance from the user to the frame 301 (e.g., the handle frame 315). For example, in one or more embodiments, the predefined spatial envelope extends from the rear ends of the longitudinal segments 323, 324 of the handle frame 315 to a position within several inches of the rounded portion 325 of the handle frame 315. The predefined spatial envelope may be stored in the memory devices of the electronics modules 312, 313 (i.e., stored locally) or may be stored in a remote server (e.g., in the “cloud”) accessible by the network adapter of the mobility assistance device 300.

Furthermore, in one or more embodiments, the software instructions, when executed by the processor, cause the processor to control the electric motors 306, 307 and/or apply brakes coupled to the rear wheels 302, 303 to adjust the speed of the mobility assistance device 300 when the position of the user's body, or at least a portion thereof, is outside of the predefined spatial envelope (e.g., outside of the spatial envelope within the interior space 326 defined by the handle frame 315). For example, in one or more embodiments, when the user's body is too far away from the frame 301 of the mobility assistance device 300 (as illustrated, for example, in FIG. 3B), the software instructions, when executed by the processor, may cause the processor to disengage or override the user's inputs to the hand controls 310, 311 and/or engage the brakes to slow down the mobility assistance device 300 and thereby allow the user to catch up to the mobility assistance device 300 and re-enter the predefined spatial envelope (e.g., the user is spaced forward of the rearward ends of the longitudinal segments 323, 324 of the handle frame 315). In one or more embodiments, when the user's body is too close to the frame 301 of the mobility assistance device 300 (as illustrated, for example, in FIG. 3C), the software instructions, when executed by the processor, may cause the processor to increase the power output from the power supply modules 308, 309 to the electric motors 306, 307 to increase the speed of the mobility assistance device 300 beyond the speed of the user and thereby create sufficient distance between the user and the frame 301 of the mobility assistance device 300 such that the user's body re-enters the predefined spatial envelope (e.g., the user is sufficiently spaced behind the rounded portion 325 of the handle frame 315).

Additionally, in the illustrated embodiment, the mobility assistance device 300 configured to capture a profile of the user's body (or a portion thereof) during use of the mobility assistance device 300. The user profile may be captured by the cameras 327, 328 and/or one or more distance sensors (e.g., an array of distance sensors) facing inward toward the interior space 326 of the handle frame 315. As described in more detail below, the profile of the user captured by the 327, 328 and/or the one or more distance sensors may be utilized to determine if the user of the mobility assistance device 300 is impaired, such as experiencing excessive fatigue or disorientation, which may necessitate ceasing operation of the mobility assistance device 300, or if the user's posture is sub-optimal, which may necessitate prompting the user to adjust his or her posture to achieve greater therapeutic effect. The distance sensors may be any suitable type or kind of distance sensor, such as, for example, an optical distance sensor (e.g., a laser distance sensor). The distance sensors may be coupled to any portion of the frame 301 suitable for enabling the distance sensors to capture the user's profile during use of the mobility assistance device 300. For example, in one or more embodiments, the mobility assistance device 300 may include a series of distance sensors arranged along the handle frame 315 and oriented inward toward the interior space 326 configured to accommodate the user. In general, the increasing the number of distance sensors increases the details of the user's posture that may be capture by the distance sensors. In one or more embodiments, the cameras 327, 328 may be utilized instead of, or in conjunction with, the one or more distance sensors to obtain the profile of the user using the mobility assistance device 300.

The distance sensors and/or the cameras 327, 328 are configured to generate a matrix of three-dimensional data points that represents the posture of the user. The matrix of three-dimensional data points may be generated by the distance sensors and/or the cameras continuously or substantially continuously or at regular intervals, such as, for example, at an interval within a range from approximately 1 second to approximately 60 seconds. Increasing the number of distance sensors and/or cameras 327, 328 increases the size of the matrix, and in one or more embodiments the distance sensors and/or the cameras 327, 328 may be configured to capture more data (e.g., images and/or distance measurements) of a particular area of the user's body. For instance, in or more embodiments, if the user suffers from a limb injury or birth defect (e.g., a foot or hand injury or birth defect), the distance sensors and/or the cameras 327, 328 may be configured to capture more data from these body parts than other parts of the user's body such that the matrix contains more three-dimensional data points from these body parts of the user than other body parts of the user.

In one or more embodiments, the memory devices of the electronics modules 312, 313 include a baseline reference profile against which the profile of the user, captured from the one or more distance sensors and/or the cameras 327, 328, may be compared in real-time or substantially in real-time. In one or more embodiments, the baseline reference profile against which the posture of the user is compared may be stored in one or more remote servers (e.g., in the “cloud”), and the network adapter of the electronic modules 312, 313 may be utilized to communicate with the remote server(s). The baseline reference profile may be an idealized profile or an actual posture profile of the user captured, for example, by the one or more distance sensors and/or the cameras 327, 328. Generating the baseline reference profile from an actual posture profile of the user would enable the system to account for the unique physical features of the user. In one or more embodiments, the baseline reference profile may be stored as a matrix of three-dimensional data points representing the proper posture of the user.

In one or more embodiments, the memory device includes instructions stored therein which, when executed by the processor, cause the processor to receive or generate the matrix of three-dimensional data points captured by the one or more distance sensors and/or the cameras 327, 328 that represents the profile of the user, and compare the matrix of three-dimensional data points representing the real-time or substantially real-time posture of the user against the matrix of three-dimensional data points representing the baseline reference profile of the user. In one or more embodiments, the software instructions stored in the memory, when executed by the processor, cause the processor to cease operation of the mobility assistance device 300 (e.g., cutoff power from the power supply modules 308, 309 to the electric motors 306, 307 and/or apply the brakes), and/or signal an alert, as described in more detail below, if the result of the comparison between the user's profile and the baseline reference profile indicates that the user's profile exceeds a permissible difference from the baseline reference profile. In one or more embodiments, the algorithm for comparing the profile of the user captured by the cameras 327, 328 and/or the distance sensors to the baseline profile may be stored in one or more remote servers (e.g., in the “cloud”), and the electronic modules may include a network adapter for communicating with the remote server(s).

In one or more embodiments, the memory device of the electronics modules 312, 313 includes an artificial neural network trained on profile data (e.g., profile images) of users (e.g., the artificial neural network may be trained on a data set including acceptable user profiles (positive training set) and unacceptable user profiles (negative training set)). In one or more embodiments, the artificial neural network may be stored on a remote server accessible by the network adapter in the electronic modules 312, 313. In one or more embodiments, the instructions stored in the memory, when executed by the processor, cause the processor to input the user profile, as captured by the one or more distance sensors and/or the cameras 327, 328, into an input layer of the artificial neural network, and receive an output from an output layer of the artificial neural network that results from the inference process performed by the artificial neural network. In one or more embodiments, the software instructions stored in the memory, when executed by the processor, cause the processor to cease operation of the mobility assistance device 300 (e.g., cutoff power from the power supply modules 308, 309 to the electric motors 306, 307 and/or apply the brakes) and/or signal an alert if the artificial neural network inference process classifies the user's posture as unacceptable. In one or more embodiments, the artificial neural network for comparing the profile of the user captured by the cameras 327, 328 and/or the distance sensors to the baseline profile may be stored in one or more remote servers (e.g., in the “cloud”) accessible by the mobility assistance device 300.

With continued reference to the embodiment illustrated in FIGS. 3A-3C, the portable electronic device 330 (e.g., a tablet computer or a smart phone) includes a display, a global positioning system (GPS) chip, a cellular chip, a wireless communications chip (e.g., a Wi-Fi chip), and a short-wave wireless communication chip (e.g., a Bluetooth™ chip). In one or more embodiments, the instructions stored in one of the memory devices, when executed by one of the processors of the electronics modules 312, 313, cause the processor to display a visual alert on the display of the portable electronic device 330 if the user's profile, when compared against the baseline user profile, is classified as unacceptable and/or if the position of the user's body, or at least a portion thereof, is outside of the predefined spatial envelope.

In one or more embodiments, the portable electronic device 330 may be utilized to display visual depictions of navigation directions on the display of the portable electronic device 330.

The cellular chip in the portable electronic device 330 enables the user to summon emergency assistance if there is a medial, criminal, or other issue requiring intervention. The GPS chip and/or the Wi-Fi chip may aid in establishing an accurate location of the mobility assistance device 300 when the emergency call is placed. Additionally, the ability for the user to converse with emergency personnel over the cellular connection offers additional authentication to the emergency call. In one or more embodiments, the memory includes software instructions stored therein which, when executed by the processor, cause the processor transmit, via the network adapter, one or more images captured by the cameras 327, 328, such as, for instance, one or more images of the user and/or the area surrounding the mobility assistance device 300, which may aid emergency personnel in qualifying the nature of the emergency call.

Additionally, the wireless connectivity provided by the cellular chip and/or the Wi-Fi chip enable the location of the mobility assistance device 300 to be tracked so, for example, family members and caregivers can locate the user of the mobility assistance device 300. The wireless connectivity may also enable the user to locate the mobility assistance device 300 if, for example, the user cannot recall where he or she left it.

The cellular chip and/or the Wi-Fi chip also enable the user to access smart speaker services of the electronic device, such as Siri, Alexa, Katana, or Hey Google. Utilizing the smart speaker services, the user can make hands-free telephone calls, such as to emergency personnel (e.g., the user can make telephone calls through the speakerphone capabilities built into the portable electronic device 330, such as the smartphone or tablet computer).

In the illustrated embodiment, the stereo camera 329 and/or other suitable distance sensor are coupled to the handle frame 315 and oriented forward (i.e., in a direction of forward travel of the mobility assistance device 300). The distance sensors may be any suitable type or kind of range finding sensor, such as, for example, optical or ultrasonic range finders. The stereo camera 329 and/or the distance (and in one or more embodiments, the cameras) are configured to capture data (e.g., image data) of the environment proximate to the mobility assistance device 300.

In one or more embodiments, the memory device of the electronics modules 312, 313 includes an artificial neural network trained to classify environmental objects (e.g., an artificial neural network configured to perform semantic segmentation of the natural environment, such as trees, and manmade structures, such as stairs, streets, curbs, and sidewalks). In one or more embodiments, the artificial neural network is trained to classify environmental objects and/or environmental conditions in an environmental scene as either hazardous or non-hazardous. In one or more embodiments, the artificial neural network may be stored on a remote server accessible by the network adapter in the electronics modules 312, 313. In one or more embodiments, the instructions stored in the memory, when executed by the processor, cause the processor to input the environmental scene data (captured by the stereo camera 329, the distance sensor, and/or the cameras 327, 328) into an input layer of the artificial neural network, and receive an output from an output layer of the artificial neural network that results from the inference process performed by the artificial neural network. In one or more embodiments, the software instructions stored in the memory, when executed by the processor, cause the processor to cease operation of the mobility assistance device 300 or at least reduce the speed of the mobility assistance device 300 (e.g., cutoff power from the power supply modules 308, 309 to the electric motors 306, 307 and/or apply the brakes) and/or signal an alert (e.g., display an alert notification on the display of the portable electronic device 330) if the artificial neural network inference process classifies one or more objects or conditions in the environmental scene data as hazardous. For instance, in one or more embodiments, if the artificial neural network classifies an object in the environmental scene captured by the stereo camera 329, the distance sensor, and/or the cameras 327, 328 as a staircase, the software instructions stored in the memory, when executed by the processor, may cause the processor to display a warning on the display of the electronic device 330 and/or cease movement of the mobility assistance device 300 in the direction of the staircase by actuating the brakes and/or cutting off the power supply from the power supply modules 308, 309 to the electric motors 306, 307. In one or more embodiments, if the artificial neural network classifies an object in the environmental scene captured by the stereo camera 329, the distance sensor, and/or the cameras 327, 328 as hazardous, the software instructions stored in the memory, when executed by the processor, may cause the processor to display directions on the display of the electronic device 330 that enable the user to avoid the hazardous object or hazardous condition.

In one or more embodiments, the mobility assistance device 300 includes one or more haptic feedback devices. In one or more embodiments, the mobility assistance device 300 may include at least one haptic feedback device 331, 332 in each of the hand controls 310, 311, respectively. The haptic feedback devices 331, 332 may be any suitable type or kind of haptic feedback devices, such as, for example, an eccentric rotating mass (ERM) actuator, a linear resonant actuator (LRA), or a piezoelectric actuator. In one or more embodiments, the alert signaled by the processor (e.g., when the position of the user is outside the predefined spatial envelope, the user's posture is unacceptable, and/or a hazardous object or condition is detected in the path of travel of the mobility assistance device 300) may include activating the one or more haptic feedback devices 331, 332, which provides a tactile sensation to one or both of the user's hands to alert the user to the dangerous situation or condition.

In one or more embodiments, the mobility assistance device 300 may be configured to identify individuals and/or confirm the authenticity of personnel in the vicinity of the mobility assistance device 300 utilizing facial recognition. In one or more embodiments, the memory device of the electronics modules 312, 313 may include an artificial neural network trained to classify facial images captured by the cameras 327, 328 and/or the stereo camera 329 as a friend, an acquaintance, or an authorized personnel, such as valid law enforcement, nurses, or first responders (e.g., the memory may include an artificial neural network configured to perform semantic segmentation of the images captured by the cameras 327, 328 and/or the stereo camera 329 to identify human faces associated with the user's friends, the user's acquaintances, or authorized personnel). In one or more embodiments, the artificial neural network may be stored on a remote server accessible by the network adapter in the electronics modules 312, 313. In one or more embodiments, the instructions stored in the memory, when executed by the processor, cause the processor to input the images captured by the cameras 327, 328 and/or the stereo camera 329 into an input layer of the artificial neural network, and receive an output from an output layer of the artificial neural network that results from the inference process performed by the artificial neural network. In one or more embodiments, if the artificial neural network inference process classifies a facial image captured by the cameras as a friend, an acquaintance, or an authorized personnel, the software instructions stored in the memory, when executed by the processor, may cause the processor to notify the user audibly, visually, or through tactile sensation (e.g., haptic feedback through the haptic feedback devices 331, 332). For example, in one or more embodiments, the instructions stored in memory, when executed by the processor, may cause the processor to display, on the display of the portable electronic device 330, one or more images of the user's friend or acquaintance and/or to display an indication that the individual is authorized personnel, such as a valid law enforcement office, nurse, or first responder.

In one or more embodiments, the mobility assistance device 300 may be configured to identify dangerous or threatening objects, such as guns and knives. In one or more embodiments, the memory device of the electronics modules 312, 313 may include an artificial neural network trained to classify objects contained in images captured by the cameras 327, 328 and/or the stereo camera 329 as dangerous or not dangerous (e.g., the memory may include an artificial neural network configured to perform semantic segmentation of the images captured by the cameras 327, 328 and/or the stereo camera 329 to identify dangerous objects). In one or more embodiments, the artificial neural network may be stored on a remote server accessible by the network adapter in the electronics modules 312, 313. In one or more embodiments, the instructions stored in the memory, when executed by the processor, cause the processor to input the images captured by the cameras 327, 328 and/or the stereo camera 329 into an input layer of the artificial neural network, and receive an output from an output layer of the artificial neural network that results from the inference process performed by the artificial neural network. In one or more embodiments, if the artificial neural network inference process classifies an object contained in an image captured by the cameras 327, 328 and/or the stereo camera 329 as a dangerous object, the software instructions stored in the memory, when executed by the processor, may cause the processor to notify the appropriate authorities, such as police or security personnel, via a cellular or WiFi connection of the mobility assistance device 300.

In one or more embodiments, the mobility assistance device 300 may be operable by voice commands from the user. In one or more embodiments, the memory of the portable electronic device 330 may include speech recognition algorithm or an artificial neural network trained to recognize certain voice commands from the user and operate the mobility assistance device 300 in response to those voice commands. For instance, in one or more embodiments, the artificial neural network may be trained to recognize various operational and directional commands, such as, for example, “go forward,” “reverse,” “stop,” “left,” “right,” or “go to Mary's house.” Additionally, in one or more embodiments, the memory may include software instructions which, when executed by the processor, cause the processor to drive and steer the mobility assistance device 300 (e.g., by supplying power, equally or differentially, from the power supply modules 308, 309 to the electric motors 306, 307) in accordance with the recognized voice commands. In one or more embodiments, the memory may include software instructions which, when executed by the processor, cause the processor access the geographic coordinates of the mobility assistance device 300 (e.g., by accessing data from the on-board GPS chip), obtain the geographic coordinates or the address associated with the destination in the recognized voice command, generate directions from the mobility assistance device 300 to the destination, and drive and steer the mobility assistance device 300 (e.g., by supplying power, equally or differentially, from the power supplies to the electric motors) to autonomously navigate the mobility assistance device 300 to the destination. In one or more embodiments, the speech recognition algorithm or the artificial neural network may be stored on a remote server accessible by the network adapter in the portable electronic device 330.

In one or more embodiments, the mobility assistance device 300 may be configured to autonomously navigate to the user. For instance, in one or more embodiments, the memory device of at least one of the electronics modules 312, 313 may include one or more facial recognition algorithms configured to classify facial images captured by the cameras 327, 328 as either an authorized user or an unauthorized user. In one or more embodiments, the memory device of the electronics modules 312, 313 may include an artificial neural network trained to classify facial images captured by the cameras 327, 328 as either an authorized users or an unauthorized user (e.g., the memory may include an artificial neural network configured to perform semantic segmentation of the images captured by the cameras to identify human faces and classify the human faces as either authorized or unauthorized users). In one or more embodiments, the artificial neural network may be stored on a remote server accessible by the network adapter in one of the electronics modules 312, 313. In one or more embodiments, the instructions stored in the memory, when executed by the processor, cause the processor to input the images captured by the cameras 327, 328 into an input layer of the artificial neural network, and receive an output from an output layer of the artificial neural network that results from the inference process performed by the artificial neural network. In one or more embodiments, if the artificial neural network inference process classifies a facial image captured by the cameras 327, 328 as an authorized user, the software instructions stored in the memory, when executed by the processor, cause the processor to drive and steer the mobility assistance device 300 (e.g., by supplying power, equally or differentially, from the power supply modules 308, 309 to the electric motors 306, 307) toward the authorized user.

In one or more embodiments, the mobility assistance device 300 may include a portable near-field communication (NFC) transmitter that may be carried or worn by a user to enable the mobility assistance device 300 to autonomously navigate to the user. For instance, in one or more embodiments, one of the electronics modules 312, 313 may include an NFC receiver (e.g., an antenna) configured to receive signals from the NFC transmitter, and the signals transmitted from the NFC transmitter and received by the NFC receiver may include location data (e.g., GPS coordinates) of the NFC transmitter. Additionally, in one or more embodiments, the memory device in one of the electronics modules 312, 313 may include software instructions which, when executed by the processor, cause the processor to drive and steer the mobility assistance device 300 (e.g., by supplying power, equally or differentially, from the power supply modules 308, 309 to the electric motors 306, 307) toward the NFC transmitter when a signal is received by the NFC receiver from the NFC transmitter.

In one or more embodiments, the mobility assistance device 300 may be configured to autonomously navigate to a base charging station when, for example, the remaining power supply in the power supply modules 308, 309 drops below a threshold power supply level. For example, in one or more embodiments, the memory device of one of the electronics modules 312, 313 may include an artificial neural network trained to classify images and identify the base charging station (e.g., the memory may include an artificial neural network configured to perform semantic segmentation of the images captured by the cameras 327, 328 and/or the stereo camera 329 to identify the base charging station). In one or more embodiments, the artificial neural network may be stored on a remote server accessible by the network adapter in one of the electronics modules 312, 313. In one or more embodiments, the instructions stored in the memory, when executed by the processor, cause the processor to input the images captured by the cameras 327, 328 and/or the stereo camera 329 into an input layer of the artificial neural network, and receive an output from an output layer of the artificial neural network that results from the inference process performed by the artificial neural network. In one or more embodiments, if the artificial neural network inference process classifies an object in an image captured by the cameras 327, 328 and/or the stereo camera 329 as the base charging station, the software instructions stored in the memory, when executed by the processor, cause the processor to drive and steer the mobility assistance device 300 (e.g., by supplying power, equally or differentially, from the power supply modules 308, 309 to the electric motors 306, 307) toward the base charging station when, for example, the power level of the power supply modules 308, 309 drop below a minimum threshold power level or when the user prompts the mobility assistance device 300 to dock with the base charging station to recharge the power supply modules 308, 309.

In one or more embodiments, the base charging station may include an NFC transmitter to enable the mobility assistance device 300 to autonomously navigate to the base charging station. For instance, in one or more embodiments, one of the electronics modules 312, 313 may include an NFC receiver (e.g., an antenna) configured to receive signals from the NFC transmitter, and the signals transmitted from the NFC transmitter and received by the NFC receiver may include location data (e.g., GPS coordinates) of the NFC transmitter. Additionally, in one or more embodiments, the memory may include software instructions which, when executed by the processor, cause the processor to drive and steer the mobility assistance device 300 (e.g., by supplying power, equally or differentially, from the power supply modules 308, 309 to the electric motors 306, 307) toward the NFC transmitter and to dock with the base charging station when, for example, the power level of the power supply modules 308, 309 drop below a minimum threshold power level or when the user prompts the mobility assistance device 300 to dock with the base charging station to recharge the power supply modules 308, 309.

In one or more embodiments, the mobility assistant device 300 may be configured to provide one or more augmented reality functions on the display of the portable electronic device 330. For instance, in one or more embodiments, the memory of the portable electronic device 330 may include software instructions which, when executed by the processor, cause the processor receive an input from a user including the user's desired destination, obtain directions to the desired destination, display a scene captured by the cameras 327, 328 and/or the stereo camera 329 on the display of the portable electronic device 330, and overlay graphical depictions (e.g., arrows) of the directions on the scene captured by the cameras 327, 328 and/or the stereo camera 329. For instance, in one or more embodiments, when a user approaches an intersection, the software instructions, when executed by the processor, may cause the processor to display an animated arrow on the display overlaid on the scene captured by the cameras 327, 328 and/or the stereo camera 329 that indicates the direction in which the user should turn to reach the destination.

In one or more embodiments, the memory of the electronics module may include software instructions which, when executed by the processor, cause the processor receive geographic coordinates of one or more points of interest (e.g., friends, relatives, and/or stores) proximate to the mobility assistance device 300, display a scene captured by the cameras 327, 328 and/or the stereo camera 329 on the display of the portable electronic device 330, and overlay graphical depictions of the one or more points of interest on the scene captured by the cameras 327, 328 and/or the stereo camera 329. The graphical depictions of the one or more points of interest may include an indication of the distance from the mobility assistance device 300 to the one or more points of interest and/or directions to the one or more points of interest.

In one or more embodiments, the memory of the portable electronic device 330 may include software instructions which, when executed by the processor, cause the processor to receive bus or train departure/arrival schedules to desired locations for buses or trains proximate to the mobility assistance device 300, and overlay graphical depictions of the bus or train departure/arrival schedule on the scene captured by the cameras 327, 328 and/or the stereo camera 329. In one or more embodiments, the memory of the portable electronic device 330 may include software instructions which, when executed by the processor, cause the processor to receive information regarding the boarding locations for the bus or train, and overlay a graphical depiction of the boarding locations on the scene captured by the cameras 327, 328 and/or the stereo camera 329.

In one or more embodiments, the memory of the portable electronic device 330 may include software instructions which, when executed by the processor, cause the processor to receive an emergency broadcast signal (e.g., via the network adapter and the wireless chip of the portable electronic device 330) and overlay directions on the scene captured by the cameras 327, 328 and/or the stereo camera 329 directed the user away from the emergency.

In one or more embodiments, the memory of the portable electronic device 330 may include software instructions which, when executed by the processor, cause the processor to access a crime database (e.g., access, via the network adapter and the wireless chip of the portable electronic device 330, a crime database stored on a remote server), obtain criminal activity information for an area in which the mobility assistance device 300 is located, and display the criminal activity information on the display of the portable electronic device 330.

In one or more embodiments, the memory of the portable electronic device 330 may include software instructions which, when executed by the processor, cause the processor to receive information, such as special offers, from stores located proximate to the mobility assistance device 300 and display the information on the display of the portable electronic device 330.

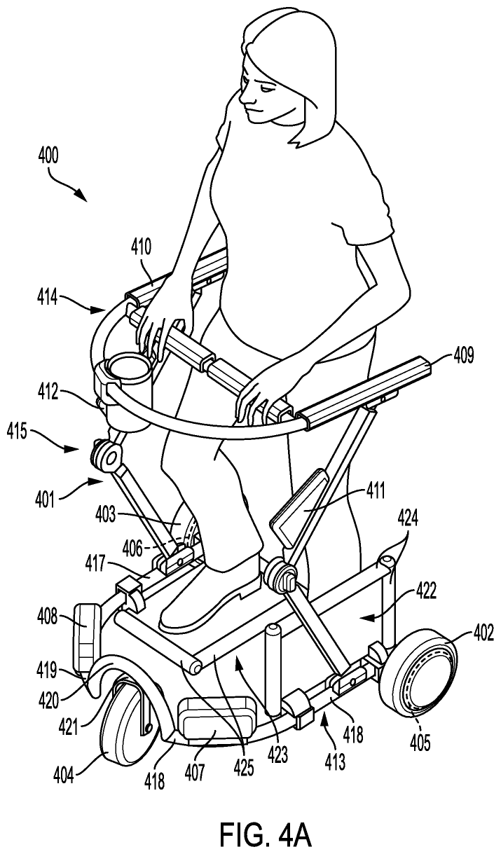

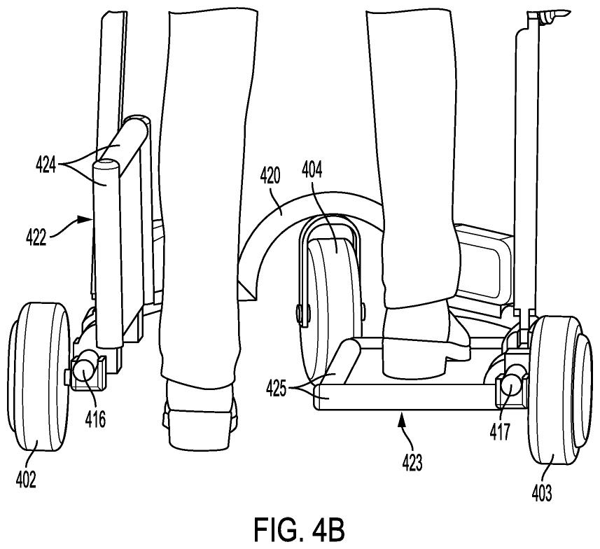

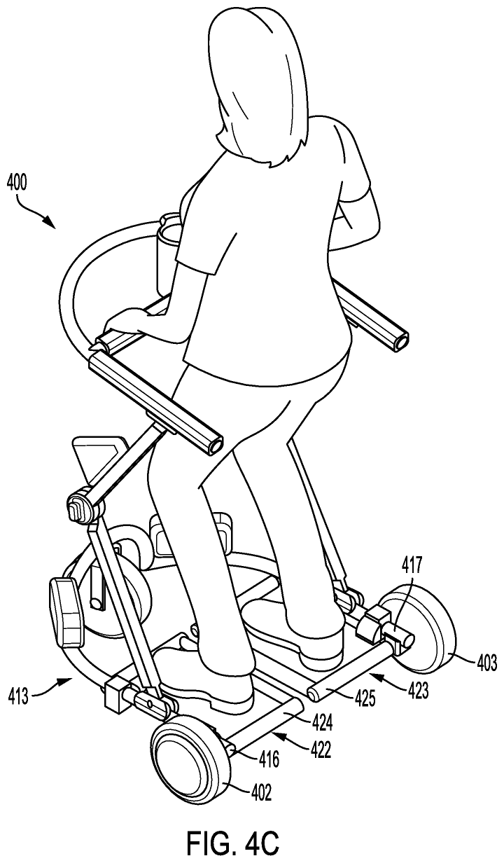

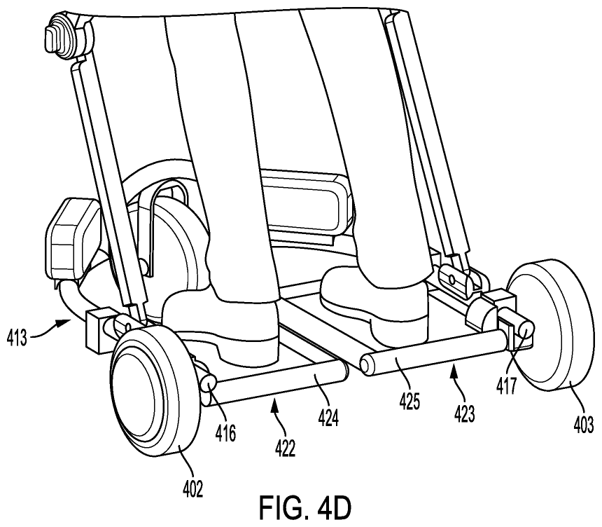

FIGS. 4A-4D illustrate a mobility assistance device 400 according to another embodiment of the present disclosure. In the illustrated embodiment, the mobility assistance device 400 includes a frame 401, a pair of rear wheels 402, 403 coupled to the frame 401, a front wheel 404 coupled to the frame 401, first and second electric motors 405, 406 operably coupled to the rear wheels 402, 403, respectively, first and second power supply modules 407, 408 configured to supply power to the first and second electric motors 405, 406, respectively, hand controls 409, 410 coupled to the frame 401 and configured to control operation of the first and second electric motors 405, 406, respectively, and first and second electronics modules 411, 412 coupled to the frame 401.

In the illustrated embodiment, the frame 401 includes a base frame 413, a handle frame 414, and a collapsible support frame 415 extending from the base frame 413 to the handle frame 414. Additionally, in the illustrated embodiment, the base frame 413 includes a pair of spaced apart longitudinal members 416, 417, a pair of angled members 418, 419 extending inward from forward ends of the longitudinal members 416, 417, and a curved member 420 extending upward and connecting inner ends of the angled members 418, 419 together. In the illustrated embodiment, the front wheel 404 is coupled to the curved member 420 with a caster 421 such that the front wheel 404 is freely turning (e.g., not electromotively driven) and the curved member 420 defines a space accommodating the lateral turning of the front wheel 404.

The configuration of the mobility assistance device 400 may be the same as the configuration of the mobility assistance device 300 illustrated in FIGS. 3A-3C, with the exception of a pair of foot boards 422, 423 coupled to the base frame 413. Accordingly, a detailed discussion of the components and features that are common with the embodiment of the mobility assistance device 300 illustrated in FIGS. 3A-3C is omitted for brevity.

In the illustrated embodiment, the first foot board 422 is coupled to the first longitudinal member 416 of the base frame 413 and the second foot board 423 is coupled to the second longitudinal member 417 of the base frame 413. In the illustrated embodiment, the first foot board 422 is longitudinally aligned or substantially longitudinally aligned with the second foot board 423 (e.g., the first foot board 422 is opposite the second foot board 423). Additionally, in the illustrated embodiment, the first and second foot boards 422, 423 are each rotatably coupled to the base frame 413 (e.g., the first foot board 422 is rotatably coupled to the first longitudinal member 416 and the second foot board 423 is rotatably coupled to the second longitudinal member 417) such that the first and second foot boards 422, 423 are each configured to move between a stowed configuration and a deployed configuration. FIGS. 4A-4B illustrate the first foot board 422 in the stowed configuration and the second foot board 423 in the deployed configuration, and FIGS. 4C-4D illustrate both of the foot boards 422, 423 in the deployed configuration. The foot boards 422, 423 enable a user to utilize the mobility assistance device 400 without having to walk with one or both of his or her feet. In this manner, the foot boards 422, 423 enable a user suffering from fatigue or exhaustion to continue using the mobility assistance device 400 (i.e., the foot boards 422, 423 allow the user to rest one or both of his legs and feet) and enable a user with an injury, a birth-defect, or other physical impairment to one or both legs or feet (or portions thereof) to utilize the mobility assistance device 400. In one or more embodiments in which the user needs only a single foot board, the mobility assistance device 400 may be equipped with only a single foot board 422 or 423. One or both of the foot boards illustrated 422, 423 in FIGS. 4A-4D may be incorporated into any other embodiment of the mobility assistance device disclosed herein.

Additionally, in the illustrated embodiment, pads 424, 425 (e.g., foam cushions) are provided along the perimeter (or at least a portion thereof) of each of the foot boards 422, 423, respectively. The pads 424, 425 are configured to protect the user and are configured to provide a visual indication aiding the user in placing (e.g., centering) his or her feet on the foot boards 422, 423. In one or more embodiments, the mobility assistance device 400 may be provided without the pads 424, 425. Additionally, in one or more embodiments, the mobility assistance device 400 may include a foldable seat coupled to the frame 401 that is configured to move between a stowed configuration and a deployed configuration. In one or more embodiments, the mobility assistance device 400 may be provided with the foldable seat instead of, or in addition to, the one or more foot boards 422, 423.

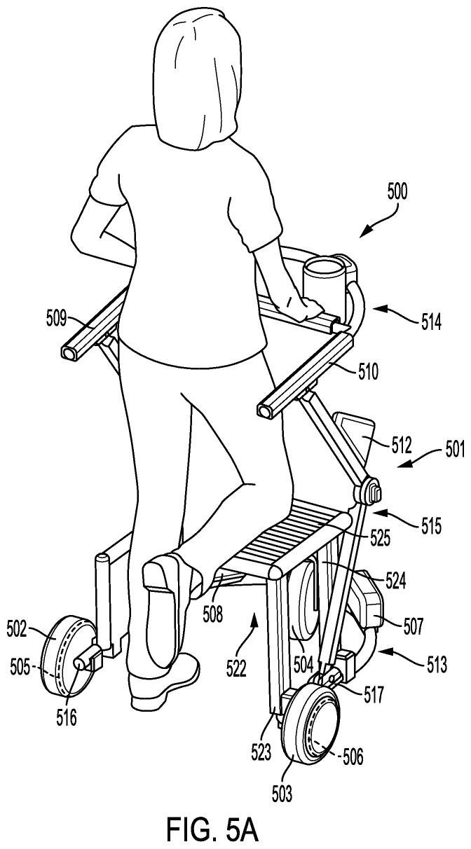

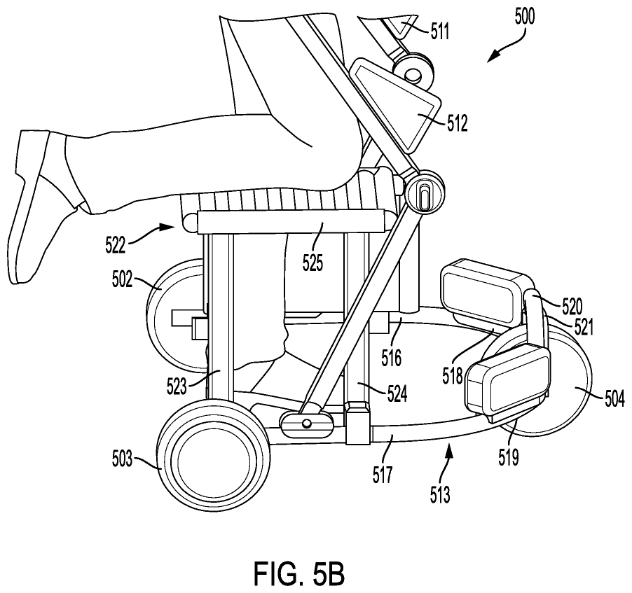

FIGS. 5A-5B illustrate a mobility assistance device 500 according to another embodiment of the present disclosure. In the illustrated embodiment, the mobility assistance device 500 includes a frame 501, a pair of rear wheels 502, 503 coupled to the frame 501, a front wheel 504 coupled to the frame 501, first and second electric motors 505, 506 operably coupled to the rear wheels 502, 503, respectively, first and second power supply modules 507, 508 configured to supply power to the first and second electric motors 505, 506, respectively, hand controls 509, 510 coupled to the frame 501 and configured to control operation of the first and second electric motors 505, 506, respectively, and first and second electronics modules 511, 512 coupled to the frame 501.

In the illustrated embodiment, the frame 501 includes a base frame 513, a handle frame 514, and a collapsible support frame 515 extending from the base frame 513 to the handle frame 514. Additionally, in the illustrated embodiment, the base frame 513 includes a pair of spaced apart longitudinal members 516, 517, a pair of angled members 518, 519 extending inward from forward ends of the longitudinal members 516, 517, and a curved member 520 extending upward and connecting inner ends of the angled members 518, 519 together. In the illustrated embodiment, the front wheel 504 is coupled to the curved member 520 with a caster 521 such that the front wheel 504 is freely turning (e.g., not electromotively driven) and the curved member 520 defines a space accommodating the lateral turning of the front wheel 504.

The configuration of the mobility assistance device 500 may be the same as the configuration of the mobility assistance device 300 illustrated in FIGS. 3A-3C, with the exception of an appendage support device 522 coupled to the base frame 513. Accordingly, a detailed discussion of the components and features that are common with the embodiment of the mobility assistance device 300 illustrated in FIGS. 3A-3C is omitted for brevity.

In the illustrated embodiment, the appendage support device 522 is configured to provide support to one of the user's legs if, for example, the user has no control or limited control over that leg or a portion of the leg is amputated (e.g., if one of the user's legs is amputated at the knee). In the illustrated embodiment, the appendage support device 522 includes a pair of support members 523, 524 coupled, at their lower ends, to one of the longitudinal members 516, 517 of the base frame 513, and a support platform 525 coupled to upper ends of the support members 523, 524. In one or more embodiments, the support platform 525 may include a padded material, such as, for example, foam or rubber padding. Additionally, in the illustrated embodiment, the support members 523, 524 are height adjustable such that the height of the support platform 525 from the base frame 513 may be adjusted depending on the anatomical characteristics of the user, such as the length of the user's femur. For instance, in one or more embodiments, the support members 523, 524 may be telescopically adjustable members. Moreover, although in the illustrated embodiment the appendage support device 522 includes two support members 523, 524, in one or more embodiments, the appendage support device 522 may include any other suitable number of support members 523, 524 (e.g., a single support member or more than two support members).

In one or more embodiments, depending on the needs of the user, the appendage support device 522 may be coupled to the other longitudinal member 516, 517 of the base frame 513. Additionally, in one or more embodiments, the mobility assistance device 500 may include two appendage support devices (e.g., a first appendage support device coupled to the first longitudinal member of the base frame 513 and a second appendage support device coupled to the second longitudinal member of the base frame 513).

In one or more embodiments, the appendage support device 522 may be detachable from the base frame 513 of the mobility assistance device 500 to enable, for example, the mobility assistance device 500 to collapse into the stowed configuration.

In one or more embodiments, the mobility assistance device 500 may include a switch that may be activated when the mobility assistance device 500 is equipped with one or more appendage support devices 522. The switch may be either a physical switch (e.g., a button) or software-based feature that may be activated, for example, via a graphical user interface displayed on the electronic device or by voice command. In one or more embodiments, the memory device of the electronics module includes software instructions which, when executed by the processor, cause the processor to reduce a maximum possible speed that the mobility assistance device 500 may achieve when the switch is activated by, for example, limiting a maximum amount of power that may be supplied from the power supplies to the electric motors.

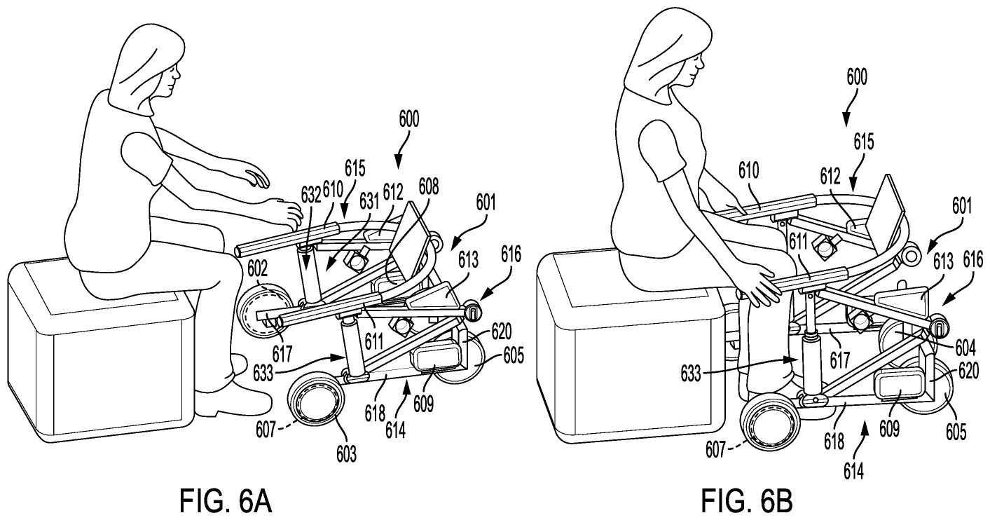

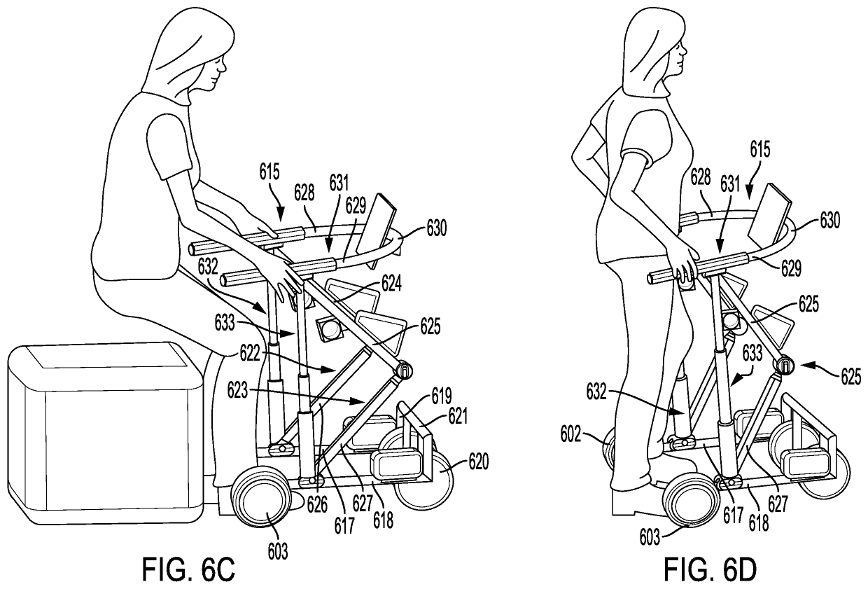

FIGS. 6A-6D illustrate a mobility assistance device 600 according to another embodiment of the present disclosure. In the illustrated embodiment, the mobility assistance device 600 includes a frame 601, a pair of rear wheels 602, 603 coupled to the frame 601, a pair of front wheels 604, 605 coupled to the frame 601, first and second electric motors 606, 607 operably coupled to the rear wheels 602, 603, respectively, first and second power supply modules 608, 609 configured to supply power to the first and second electric motors 606, 607, respectively, hand controls 610, 611 coupled to the frame 601 and configured to control operation of the first and second electric motors 606, 607, respectively, and first and second electronics modules 612, 613 coupled to the frame 601.

In the illustrated embodiment, the frame 601 includes a base frame 614, a handle frame 615, and a collapsible support frame 616 extending from the base frame 614 to the handle frame 615. Additionally, in the illustrated embodiment, the base frame 614 includes a pair of spaced apart longitudinal members 617, 618, a pair of vertical members 619, 620 extending upward from forward ends of the longitudinal members 617, 618, and a transverse member 621 extending from an upper end of one of the vertical members 619 to an upper end of the other vertical member 620.

Additionally, in the illustrated embodiment, the collapsible support frame 316 includes a pair of braces 622, 623, and each brace 622, 623 includes an upper segment 624, 625 hingedly coupled, at an upper end, to the handle frame 615 and a lower segment 626, 627 hingedly coupled, at a lower end, to the base frame 614 and hingedly coupled, at an upper end, to the upper segment 624, 625, respectively. The collapsible support frame 616 (e.g., the segments 624-627) enable the mobility assistance device 600 to move between a collapsed configuration and a deployed configuration. Each of the braces 622, 623 of the collapsible support frame 616 are configured to move between a fully collapsed configuration (shown in FIG. 6A) and a fully deployed configuration (shown in FIG. 6D). In the collapsed configuration, the handle frame 615 is proximate to the base frame 614 (e.g., the handle frame 615 is spaced a minimum distance from the base frame 614), and in the deployed configuration, the handle frame 615 is distal to the base frame 614 (e.g., the handle frame 615 is spaced a maximum distance from the base frame 614).

In the illustrated embodiment, the handle frame 615 is generally U-shaped, including a pair of spaced apart longitudinal segments 628, 629 and a rounded portion 630 connecting the longitudinal segments 628, 629 together. In the illustrated embodiment, a closed end of the handle frame 615 defined by the rounded portion 630 is proximate to a front of the mobility assistance device 600, and an open end of the handle frame 615 defined by the pair of spaced apart longitudinal segments 628, 629 is proximate to a rear of the mobility assistance device 600. The handle frame 615 defines an interior space 631 between the longitudinal segments 628, 629 and the rounded portion 630 that is configured to accommodate a user during use of the mobility assistance device 600.

The configuration of the mobility assistance device 600 may be the same as the configuration of the mobility assistance device 300 illustrated in FIGS. 3A-3C, with the exception of a pair of actuators 632, 633 extending from the base frame 614 to the handle frame 615 (e.g., a first actuator 632 extending from the first longitudinal member 617 of the base frame 614 to the first straight segment 628 of the handle frame 615, and a second actuator 633 extending from the second longitudinal member 618 of the base frame 614 to the second straight segment 629 of the handle frame 615). Accordingly, a detailed discussion of the components and features that are common with the embodiment of the mobility assistance device 300 illustrated in FIGS. 3A-3C is omitted for brevity.

The actuators 632, 633 are configured to move the mobility assistance device 600 between the collapsed and deployed configurations. The actuators 632, 633 may be any suitable type or kind of actuator, such as, for example, electromechanical actuators, hydraulic actuators, and/or pneumatic actuators. In one or more embodiments in which the actuators 632, 633 are electromechanical actuators, the actuators 632, 633 may be electrically connected to the power supply modules 608, 609, respectively, although in one or more embodiments, the actuators 632, 633 may be powered by one or more power supplies separate from the power supply modules 608, 609 configured to power the electric motors 606, 607 coupled to the rear wheels 602, 603. Additionally, in one or more embodiments, the actuators 632, 633 may have any other suitable configuration and may be located in any other suitable location on the frame 601 of the mobility assistance device 600. For instance, in one or more embodiments, the actuators 632, 633 may be integrated into the collapsible support frame 616.

The mobility assistance device 600 may be utilized to assist a user in rising from a seated position to a standing position and/or to assist a user in lowering from a standing position into a seated position. In one or more embodiments, the actuators 632, 633 are configured to retract (e.g., retract telescopically) or extend (e.g., extend telescopically) when the actuators 632, 633 are operated.

In one or more embodiments, the mobility assistance device 600 may include one or more switches for actuating the actuators 632, 633. For instance, in one or more embodiments, the mobility assistance device 600 may include a first switch configured to cause power to be supplied to the first actuator 632, and a second switch configured to cause power to be supplied to the second actuator 633. In one or more embodiments, the mobility assistance device 600 may include a single switch for activating both of the actuators 632, 633. The one or more switches may be either physical switches (e.g., buttons) or software-based feature that may be activated, for example, via a graphical user interface displayed on an electronic device or by voice command. In one or more embodiments in which the one or more switches for actuating the actuators 632, 633 are physical switches, the one or more switches may be provided on one of the hand controls 610, 611. In one or more embodiments in which the one or more switches for actuating the actuators 632, 633 are physical switches, the one or more switches may be provided in any other suitable location that is accessible by a user in a seated position or a standing position.

In operation, when the mobility assistance device 600 is in the collapsed configuration (as shown in FIG. 6A) and the switch is activated to move the mobility assistance device 600 into the deployed configuration, the actuators 632, 633 extend (e.g., extend telescopically), which causes the actuators 632, 633 to force the handle frame 615 upward away from the base frame 614 and causes the collapsible frame 616 to move into the deployed configuration. In the illustrated embodiment, as the actuators 632, 633 extend and raise the handle frame 615, the lower segment 626, 627 of each brace 622, 623 rotates in a first direction relative to the base frame 614, and the upper segment 624, 625 of each brace 622, 623 rotates in a second direction opposite to the first direction relative to the handle frame 615.

When the mobility assistance device 600 is in the deployed configuration (as shown in FIG. 6D) and the switch is activated to move the mobility assistance device 600 into the collapsed configuration, the actuators 632, 633 retract (e.g., retract telescopically), which causes the actuators 632, 633 to force the handle frame 615 downward toward the base frame 614 and causes the collapsible frame 616 to move into the collapsed configuration. In the illustrated embodiment, as the actuators 632, 633 retract and lower the handle frame 615, the lower segment 626, 627 of each brace 622, 623 rotates in a third direction opposite the first direction relative to the base frame 614, and the upper segment 624, 625 of each brace 622, 623 rotates in a fourth direction opposite to the third direction relative to the handle frame 615. In this manner, the actuation of the actuators 632, 633 is configured to raise and lower the handle frame 615 of the mobility assistance device 600 to aid a user in standing from a seated position or sitting from a standing position.

The actuators 632, 633 for raising and lowering the handle frame 615 relative to the base frame 614 to aid a user in standing from a seated position or sitting from a standing position may be provided in any other embodiment of the mobility assistance device disclosed herein.

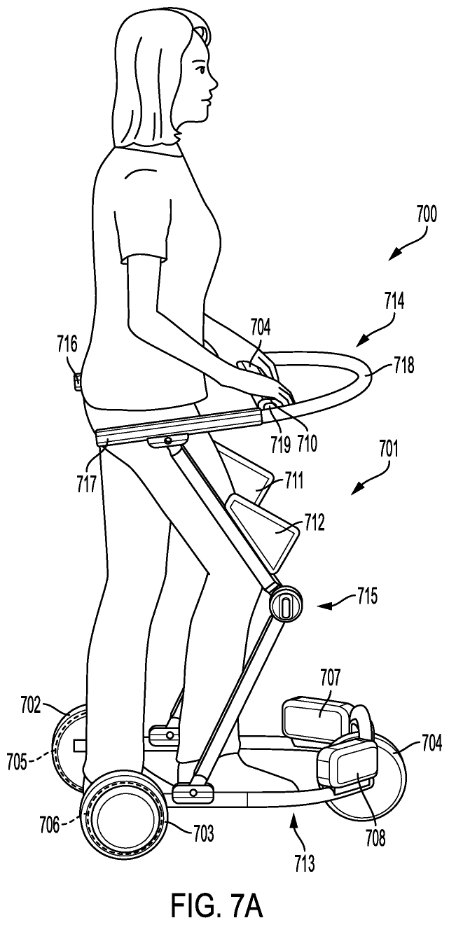

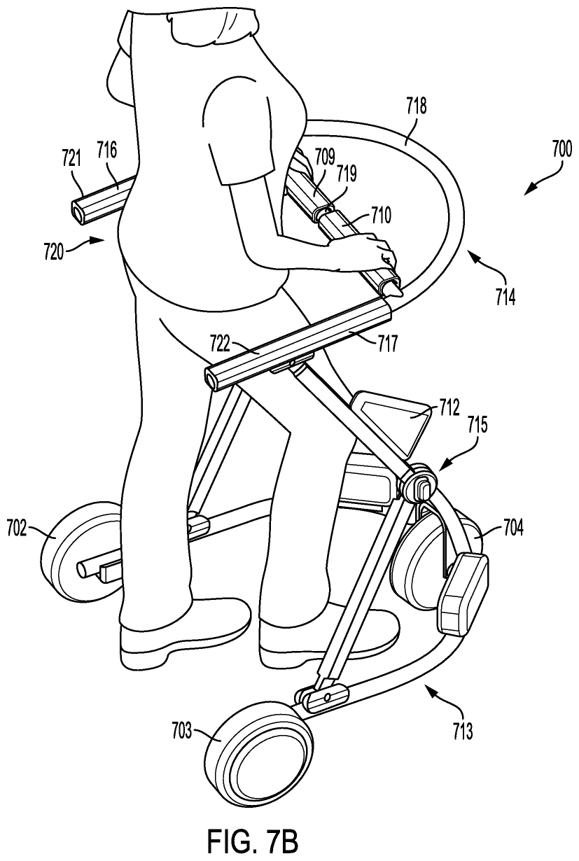

FIGS. 7A-7B illustrate a mobility assistance device 700 according to another embodiment of the present disclosure. In the illustrated embodiment, the mobility assistance device 700 includes a frame 701, a pair of rear wheels 702, 703 coupled to the frame 701, a front wheel 704 coupled to the frame 701, first and second electric motors 705, 706 operably coupled to the rear wheels 702, 703, respectively, first and second power supply modules 707, 708 configured to supply power to the first and second electric motors 705, 706, respectively, hand controls 709, 710 coupled to the frame 701 and configured to control operation of the first and second electric motors 705, 706, respectively, and first and second electronics modules 711, 712 coupled to the frame 701.

In the illustrated embodiment, the frame 701 includes a base frame 713, a handle frame 714, and a collapsible support frame 715 extending from the base frame 713 to the handle frame 714.

The configuration of the mobility assistance device 700 may be the same as the configuration of the mobility assistance device 100 illustrated in FIG. 1, with the exception of the handle frame 714 and the hand controls 709, 710. Accordingly, a detailed discussion of the components and features that are common with the embodiment of the mobility assistance device 100 illustrated in FIG. 1 is omitted for brevity.

In the illustrated embodiment, the handle frame 714 includes a pair of spaced apart longitudinal segments 716, 717 and a rounded portion 718 connecting the longitudinal segments 716, 717 together. Together, the longitudinal segments 716, 717 and the rounded portion 718 define a generally U-shaped member. Additionally, in the illustrated embodiment, the handle frame 714 includes a lateral crossbar 719 extending between the longitudinal segments 716, 717. In the illustrated embodiment, a closed end of the handle frame 714 defined by the rounded portion 718 is proximate to a front of the mobility assistance device 700, and an open end of the handle frame 714 defined by the pair of spaced apart longitudinal segments 716, 717 is proximate to a rear of the mobility assistance device 700. The handle frame 714 defines an interior space 720 between the longitudinal segments 716, 717 and the lateral crossbar 719 that is configured to accommodate a user during use of the mobility assistance device 700 and that is accessible to the user through the open end of the handle frame 714.

In the illustrated embodiment, the first and second hand controls 709, 710 are coupled, side-by-side, to the lateral crossbar 719. Accordingly, when the user is standing in the interior space 720 of the handle frame 714, the hand controls 709, 710 on the lateral crossbar 719 are directly in front of the user. The hand controls 709, 710 are configured to drive and steer (and, optionally, brake) the mobility assistance device 700. In the illustrated embodiment, each of the hand controls 709, 710 is configured to rotate (e.g., rotate about an axial axis of the lateral crossbar 719 of the handle frame 714). In one or more embodiments, the forward rotation of the first hand control 709 is configured to actuate the first electric motor 705 to drive the first rear wheel 702 forward, and the rearward rotation of the first hand control 709 is configured to actuate the first electric motor 705 in reverse to drive the first rear wheel 702 rearward. Similarly, the forward rotation of the second hand control 710 is configured to actuate the second electric motor 706 to drive the second rear wheel 703 forward, and the rearward rotation of the second hand control 710 is configured to actuate the second electric motor 706 in reverse to drive the second rear wheel 703 rearward. In one or more embodiments, the power supplied by the electric motors 705, 706 to the rear wheels 702, 703, and thus the speed at which the rear wheels 702, 703 are driven, is proportional to the angular displacement and/or the angular force applied to the respective hand controls 709, 710.

Additionally, in the illustrated embodiment, the mobility assistance device 700 includes hand grips 721, 722 (e.g., foam or rubber pads) extending along at least portions of the longitudinal segments 716, 717 of the handle frame 714.

In operation, the mobility assistance device 700 may be driven forward by rotating the hand controls 709, 710 forward such that the same or substantially the same forward angular force is applied to each of the hand controls 709, 710 and/or each of the hand controls 709, 710 is displaced with the same or substantially the same forward angular displacement. In one or more embodiments, the speed at which the mobility assistance device 700 is driven forward is proportional to the forward angular force applied to the hand controls 709, 710 and/or the forward angular displacement of the hand controls 709, 710.

Additionally, in operation, the mobility assistance device 700 may be driven rearward by rotating the hand controls 709, 710 rearward such that the same or substantially the same rearward angular force is applied to each of the hand controls 709, 710 and/or each of the hand controls 709, 710 is displaced with the same or substantially the same rearward angular displacement. In one or more embodiments, the speed at which the mobility assistance device 700 is driven rearward is proportional to the rearward angular force applied to the hand controls 709, 710 and/or the rearward angular displacement of the hand controls 709, 710.

Additionally, in operation, the mobility assistance device 700 may be driven forward with a turn in one direction (e.g., veering to the left or the right) by unequally rotating the hand controls 709, 710 forward such that the forward angular force and/or the forward angular displacement of one hand control 709 or 710 is different than the forward angular force and/or the forward angular displacement of the other hand control 710 or 709. In one or more embodiments, the extent (e.g., the angle) at which the mobility assistance device 700 turns is proportional to the difference between the forward angular forces and/or the forward angular displacements of the hand controls 709, 710.

Additionally, in operation, the mobility assistance device 700 may be driven rearward with a turn in one direction (e.g., veering to the left or the right) by unequally rotating the hand controls 709, 710 rearward such that the rearward angular force and/or the rearward angular displacement of one hand control 709 or 710 is different than the rearward angular force and/or the rearward angular displacement of the other hand control 710 or 709. In one or more embodiments, the extent (e.g., the angle) at which the mobility assistance device 700 turns is proportional to the difference between the rearward angular forces and/or the rearward angular displacements of the hand controls 709, 710.

Furthermore, in operation, the mobility assistance device 700 may be turned in one direction (e.g., turned left or right without moving forward or backward) by rotating one of the hand controls 709 or 710 forward or rearward and not operating the other hand control 710 or 709. In one or more embodiments, the speed at which the mobility assistance device 700 turns is proportional to the rearward or forward angular force applied to one of the hand controls 709 or 710 and/or the rearward or forward angular displacement of one of the hand controls 709 or 710.

The lateral crossbar 719 and the hand controls 709, 710 on the lateral crossbar 719 may be incorporated into any other embodiment of the mobility assistance device disclosed herein. Accordingly, in one or more embodiments, the mobility assistance device may include both one or more rotatable handle controls 709, 710 on the lateral crossbar 719 as well as one or more slidable hand controls on the longitudinal segments 716, 717 of the handle frame 714 (e.g., hand controls 110, 111 illustrated in FIGS. 1A-16).

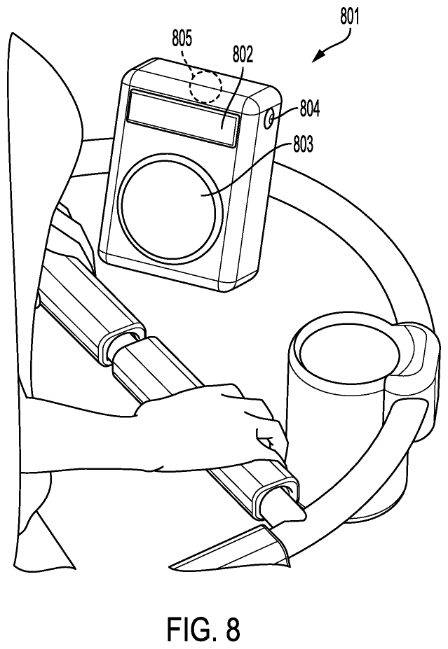

FIG. 8 illustrates an optional module 801 that may be provided on any of the embodiments of the mobility assistance device disclosed herein. In one or more embodiments, the module 801 may be detachable (e.g., the module 801 may be configured to be attached and detached from the handle frame or any other suitable portion of the frame). In one or more embodiments, the module 801 may be integrated (e.g., fixed) to the handle frame or any other suitable portion of the frame. In the illustrated embodiment, the module 801 includes a rear-facing light 802 (e.g., a rear-facing light array), a speaker 803, and a microphone 804.

In one or more embodiments in which the mobility assistance device is outfitted with portable electronic device, such as a smartphone or a tablet computer, the speaker 803 of the module 801 may be connected to the portable electronic device, via a wired connection or wireless connection, such as via a short-wave wireless communication chip (e.g., a Bluetooth™ chip). Accordingly, in one or more embodiments, speaker 803 of the module 801 is configured to transmit audio from the portable electronic device, such as audio when the user places a telephone call through the portable electronic device. Additionally, in one or more embodiments in which the mobility assistance device is outfitted with a portable electronic device, such as a smartphone or a tablet computer, the microphone 804 of the module 801 may be connected to the portable electronic device, via a wired connection or wireless connection, such as via a short-wave wireless communication chip (e.g., a Bluetooth™ chip). Accordingly, in one or more embodiments, microphone 804 of the module 801 is configured to transmit audio from the user to the portable electronic device, such as audio when the user places a telephone call or when the user issues voice commands to operate the mobility assistance device.

In one or more embodiments in which the mobility assistance device is outfitted with one or more sensors (e.g., cameras and/or distance sensors) to detect objects or conditions in a path of the mobility assistance device, the rear-facing light 802 of the module 801 may be configured to provide navigation directions to a desired destination and/or to avoid a hazardous object or situation, and/or the rear-facing light 802 may be configured to provide an alert to the user of a hazardous object or situation. For instance, in one or more embodiments, a memory device provided in the module, the portable electronic device (e.g., the smartphone or tablet computer), or the electronics module, may include instructions which, when executed by a processor, cause the processor to flash or blink the rear-facing light 802 when a hazardous object or condition is detected. In one or more embodiments, a memory device provided in the module, the portable electronic device (e.g., the smartphone or tablet computer), or the electronics module, may include instructions which, when executed by a processor, cause the processor to illuminate the rear-facing light 802 to provide directional information to the user to assist the user in reaching a desired destination (e.g., the rear-facing light 802 may be a light array, and the processor may flash a left portion of the light array to indicate a left turn is required or flash a right portion of the light array to indicate a right turn is required).

In one or more embodiments, the module 801 may also include a forward-facing light 805 configured to illuminate an area around the mobility assistance device and thereby aid the user in operating the mobility assistance device at nighttime.

In one or more embodiments, the mobility assistance device may be configured to communicate with a health monitoring device carried or worn by the user. Such health monitoring devices may be configured to monitor a variety of biometric health metrics, such as body temperature, heart rate, blood pressure, VO2 max, and/or respiratory heart rate. In one or more embodiments in which the mobility assistance device is outfitted with a portable electronic device, such as a smartphone or a tablet computer, the health monitoring device may be connected to the portable electronic device via a wired connection or wireless connection, such as via a short-wave wireless communication chip (e.g., a Bluetooth™ chip).

In one or more embodiments, a memory device provided in the module 801, the portable electronic device (e.g., the smartphone or tablet computer), or one of the electronics modules, may include instructions which, when executed by a processor, cause the processor to receive the health metric data from the health monitoring device and save the health metric data in memory. In one or more embodiments, the software instructions, when executed by a processor, may cause the processor to compare the health metric data against baseline, reference health metric data (e.g., health metric data indicated by the user's physician as normal), and provide an alert (e.g., an audible alarm, haptic feedback, and/or visual indicia, such as through a lighting system or the display of a smartphone or tablet computer) if the user's health metric data is sufficiently different than the baseline, reference health metric data. In one or more embodiments, the software instructions, when executed by a processor, may cause the processor to notify medical or emergency personnel (e.g., placing a call with the cellular chip of the smartphone or tablet computer) if the user's health metric data is sufficiently different than the baseline, reference health metric data.

Additionally, in one or more embodiments, the health metrics of the user measured by the health monitoring device may be combined with data collected by one or more sensors of the mobility assistance device, such as, for example, the posture of the user, the distance walked by the user, and/or the speed walked by the user. Together, this information may provide a comprehensive state of health of the user.

In one or more embodiments, the mobility assistance device may include one or more sensors for measuring or determining the user's weight distribution on the mobility assistance device and/or the user's points of contact with the mobility assistance device. For instance, in one or more embodiments, the hand controls and any appendage rests (e.g., the foot boards 422, 423 illustrated in FIGS. 4A-4D or the appendage support device 522 illustrated in FIGS. 5A-5B) may include one or more pressure sensors. Additionally, in one or more embodiments, the mobility assistance device includes one or more physical contact point sensors for measuring or determining the user's points of contact with the mobility assistance device. The physical contact point sensors may be any suitable type or kind of contact sensors, such as, for instance, piezoelectric sensors, capacitive touch sensors, and/or imaging elements (e.g., one or more cameras). In one or more embodiments, the physical contact sensors may be provided in the hand controls and any appendage rests (e.g., the foot boards 422, 423 illustrated in FIGS. 4A-4D or the appendage support device 522 illustrated in FIGS. 5A-5B).

In one or more embodiments, a memory device provided in the portable electronic device (e.g., the smartphone or tablet computer) or one of the electronics modules may include instructions which, when executed by a processor, cause the processor to receive the measurements from the pressure sensors and/or the contact sensors and compare these measurements to a reference weight distribution table (i.e., a lookup table) and/or a reference point of contact table (e.g., a weight distribution prescribed by the user's doctor or physical therapist to address a physical ailment, such as spinal misalignment). In one or more embodiments, the instructions, when executed by the processor, may cause the processor to provide the measurements from the pressure sensors and/or the contact sensors to the user (e.g., display the measurements on the display of the smartphone or tablet computer) and/or provide the user with corrective action to correct the user's imbalance (e.g., display instructions on the display of the smartphone or tablet computer to improve the user's weight distribution and/or points of contact with the mobility assistance device). For instance, in one or more embodiments, the instructions, when executed by the processor, may cause the processor to provide the user with instructions (e.g., instructions displayed on the display of the smartphone or tablet computer) for achieving the user's prescribed orthopedic goals.

In one or more embodiments, the cameras of the mobility assistance device may also be utilized to perform the following functions: (1) identifying and providing video and audio recordings of accidents and crime scenes (e.g., on the sidewalk, street, or adjacent buildings) to the authorities; (2) logging density of pedestrian and vehicular traffic at particular locations and times; (3) logging the location and time of license plate and vehicular information of vehicles that are parked and in motion; (4) identifying the time and location of individuals who are being sought by law enforcement; and (5) identifying hazards such as sidewalk breaks, downed light poles or power lines, debris causing issues with safe passage on sidewalks and motorways. In one or more embodiments, the mobility assistance device may be configured to provide the collected image, video, and/or audio data, via a cellular or Wi-Fi connection, in real-time or as aggregated data packets at discrete time intervals.

In one or more embodiments, the mobility assistance device may include one or more security features that require validation by an authorized user before the mobility assistance device can be operated. Validation of the identity of the authorized user may be required because, according to various embodiments, the mobility assistance device is configured to collect and/or transmit sensitive, personal information, such as user identity information, location information, health metrics, and/or facial images. In one or more embodiments, the mobility assistance device may be configured to require a combination of any two of the following validation procedures to enable operation of the mobility assistance device: (1) an NFC card with a Secure Element chip; (2) a biometric scan such as fingerprint, retinal scan, or facial recognition scan, utilizing, for instance, an onboard smartphone or tablet computer; (3) a conventional, physical key or a Universal 2^{nd} Factor key (e.g., a Ubikey™); (4) a secure wireless transmitter; (5) voice recognition; and (6) a password.

Additionally, in one or more embodiments, the mobility assistance device may be configured to utilize a secure communication connection to and from the mobility assistance device. For instance, in one or more embodiments, the mobility assistance device may be configured to utilize a blockchain to validate each packet of data sent from and received by the mobility assistance device.

Additionally, in one or more embodiments, the mobility assistance device may be configured to enable payments on the user's behalf. For instance, in one or more embodiments, once the user has securely accessed the mobility assistance device, such as by a combination of any of the two validation procedures descried above, the mobility assistance device may be configured to enable payment via an RFID chip, Apple Pay, Google Pay, a blockchain-based payment system, or any other secure payment system.

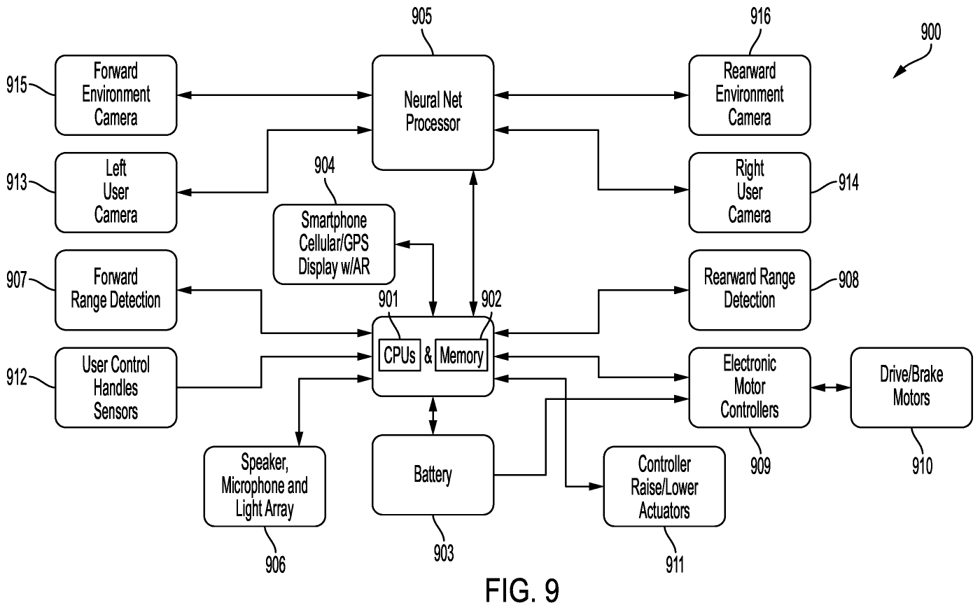

FIG. 9 is a schematic electronic block diagram of a mobility assistance device 900 according to one embodiment of the present disclosure. In the illustrated embodiment, the mobility assistance device 900 includes a central processing unit (CPU) 901, non-volatile memory 902, at least one battery 903 connected to the CPU 901, a portable electronic device 904 (e.g., a smartphone or a tablet computer with a display, a cellular chip, and a short-range wireless communication chip) connected to the CPU 901, a neural net processor 905 connected to the CPU 901, and a module 906 (e.g., a module including a speaker, a microphone, and a light array) connected to the CPU 901. Additionally, in the illustrated embodiment, the mobility assistance device 900 includes a forward range detection sensor 907 and a rearward range detection sensor 908 connected to the CPU 901, one or more electronic motor controllers 909 connected to the CPU 901, one or more drive/brake motors 910 connected to the electronic motor controllers 909, a controller 911 for raising and lowering the actuators to move the mobility assistance device between the collapsed and deployed configurations, and one or more hand control sensors 912 connected to the CPU 901. Furthermore, in the illustrated embodiment, the mobility assistance device 900 includes a left user camera 913 and a right user camera 914 connected to the neural net processor 905. As described in detail above, the neural net processor 905 is configured to process user images captured by the left and right user cameras 912, 913 to determine the posture of the user and/or the position of the user relative to the frame of the mobility assistance device 900. In the illustrated embodiment, the mobility assistance device 900 also includes a forward environment camera 915 and a rearward environment camera 916 connected to the neural net processor 905. As described above, the artificial neural net processor 905 is configured to process the environmental images captured by the forward and rearward environmental cameras 914, 915 to, for example, determine a direction of travel of the mobility assistance device, identify individuals and/or confirm the authenticity of personnel in the vicinity of the mobility assistance device utilizing facial recognition, identify dangerous or threatening objects, such as guns and knives, in proximity to the mobility assistance device, and/or identify or classify environmental objects in a scene captured by the cameras. In one or more embodiments, each of the electronic components 901-915 may be in communication with one or more of the electronic components 901-915 over a system bus. Additionally, in one or more embodiments, one or more of the electronic components 901-915 may be excluded from the mobility assistance device 900 depending on the desired functionality and cost of the mobility assistance device 900.

In one or more embodiments in which the artificial neural network is stored in the memory device of one or both of the electronics modules, the artificial neural network may be an Intel Movidius Neural Compute Stick or an Nvidia Jetson TX2. In one or more embodiments in which the artificial neural network is stored in a remote data storage device (e.g., in the “cloud”), the artificial neural network may be Microsoft Azure ML, Amazon SageMaker and ML, and/or Google ML Engine. Additionally, in one or more embodiments in which the mobility assistance device includes a 360-degree camera, the camera may be a Kodak Pixpro Orbit360 4 k or a Samsung Gear360 camera. In one or more embodiments, the portable main computing system in the electronics modules may be an Intel Compute Stick Core M3 or an AWOW Stick Cherry 432. In one or more embodiments in which the mobility assistance device includes a stereo camera and/or an IR distance sensor, the camera or sensor may be an Intel RealSense D435 or an e-con System See3CAM Tara. In one or more embodiments in which the mobility assistance device has augmented reality functionality, the augmented reality functionality may be performed by an augmented reality cloud asset, such as Amazon Sumerian or Google ARCore/ARKit.

Although in one or more embodiments the mobility assistance device may be collapsible such that the mobility assistance device is configured to move between a collapsed (or stowed) configuration and a deployed configuration, in one or more embodiments the mobility assistance device may not be collapsible. For instance, in one or more embodiments, the mobility assistance device may include a fixed or rigid support frame extending between the base frame and the handle frame.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims, and equivalents thereof. It should be understood that the drawings are not necessarily to scale and that any one or more features of an embodiment may be incorporated in addition to or in lieu of any one or more features in another embodiment. Although relative terms such as “outer,” “inner,” “upper,” “lower,” “below,” “above,” “vertical,” “horizontal,” and similar terms have been used herein to describe a spatial relationship of one element to another, it is understood that these terms are intended to encompass different orientations of the various elements and components of the invention in addition to the orientation depicted in the figures. Additionally, as used herein, the term “substantially,” “about,” “generally” and similar terms are used as terms of approximation and not as terms of degree, and are intended to account for the inherent deviations in measured or calculated values that would be recognized by those of ordinary skill in the art. Moreover, the tasks described above may be performed in the order described or in any other suitable sequence. Additionally, the methods described above are not limited to the tasks described. Instead, for each embodiment, one or more of the tasks described above may be absent and/or additional tasks may be performed. Furthermore, as used herein, when an element or layer is referred to as being “on”, “connected to”, “coupled to”, or “adjacent to” another element or layer, it can be directly on, connected to, coupled to, or adjacent to the other element or layer, or one or more intervening elements or layers may be present. In contrast, when an element or layer is referred to as being “directly on,” “directly connected to”, “directly coupled to”, or “immediately adjacent to” another element or layer, there are no intervening elements or layers present.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

What is claimed is:

1. A mobility assistance device comprising:
a frame comprising:
a base frame;
a handle frame;
a support frame extending from the base frame to the handle frame;
a plurality of wheels coupled to the base frame;
at least one electric motor coupled to at least one wheel of the plurality of wheels;
at least one power supply coupled to the at least one electric motor;
at least one electronics module coupled to the frame, the at least one electronics module comprising a memory device and a processor coupled to the memory device; and
at least one hand control coupled to the handle frame, wherein operation of the at least one hand control is configured to control operation of the at least one electric motor.

2. The mobility assistance device of claim 1, wherein the at least one hand control is configured to rotate relative to the handle frame.

3. The mobility assistance device of claim 1, wherein the at least one hand control is configured to slide linearly relative to the handle frame.

4. The mobility assistance device of claim 1, wherein the support frame is collapsible, and wherein the mobility assistance device is configured to move between a collapsed configuration and a deployed configuration.

5. The mobility assistance device of claim 4, further comprising at least one actuator extending from the base frame to the handle frame, wherein the at least one actuator is configured to move the mobility assistance device between the collapsed configuration and the deployed configuration

6. The mobility assistance device of claim 5, further comprising at least one switch coupled to the handle frame, wherein the at least one switch is configured to activate the at least one actuator.

7. The mobility assistance device of claim 1, further comprising at least one sensor coupled to the handle frame, the at least one sensor comprising at least one of a camera or a distance sensor.

8. The mobility assistance device of claim 7, further comprising instructions stored in the memory device which, when executed by the processor, cause the processor to determine a user profile from an image of a user captured by the at least one camera, and compare the user profile to a baseline reference profile.

9. The mobility assistance device of claim 7, further comprising instructions stored in the memory device which, when executed by the processor, cause the processor to:
determine a position of a user relative to the frame from data collected by the at least one sensor; and
compare the position of the user to a predefined spatial envelope defining a maximum acceptable distance and a minimum acceptable distance from the user to the frame.

10. The mobility assistance device of claim 9, wherein the instructions, when executed by the processor, further cause the processor to:
increase power supplied by the at least one power supply to the at least one electric motor when the position of the user is below the minimum acceptable distance; and
decrease power supplied by the at least one power supply to the at least one electric motor when the position of the user is exceeds the maximum acceptable distance.

11. The mobility assistance device of claim 7, further comprising an artificial neural network stored in the memory device or a remote memory device accessible by the processor.

12. The mobility assistance device of claim 11, wherein the artificial neural network is configured to identify individuals from images captured by the camera.

13. The mobility assistance device of claim 11, wherein the artificial neural network is configured to autonomously navigate the mobility assistance device based on images captured by the camera and/or data captured by the distance sensor.

14. The mobility assistance device of claim 1, further comprising a near-field communication (NFC) receiver configured to receive a signal from an NFC transmitter in a base charging station, and wherein the signal enables the mobility assistance device to autonomously navigate to the base charging station.

15. The mobility assistance device of claim 1, further comprising:
a first track extending around a first pair of wheels of the plurality of wheels; and
a second track extending around a second pair of wheels of the plurality of wheels.

16. The mobility assistance device of claim 1, further comprising at least one foot board coupled to the base frame, wherein the at least one foot board is configured to move between a stowed configuration and a deployed configuration.

17. The mobility assistance device of claim 1, further comprising at least one appendage support coupled to the base frame, wherein a height of the appendage support relative to the base frame is adjustable.

18. The mobility assistance device of claim 1, further comprising a module coupled to the handle frame, wherein the module comprises a rear-facing light, a speaker, and a microphone.

19. The mobility assistance device of claim 1, further comprising a plurality of pressure sensors in the at least one hand control.

20. The mobility assistance device of claim 1, further comprising a plurality of physical contact point sensors in the at least one hand control, wherein each of the plurality of physical contact point sensors is a piezoelectric sensor or a capacitive touch sensor.

21. The mobility assistance device of claim 1, further comprising a portable electronic device coupled to the handle frame, the portable electronic device comprising a display, a memory device, a processor, a GPS chip, a cellular chip, and a wireless communications chip, and wherein the portable electronic device is configured to respond to voice commands.

22. The mobility assistance device of claim 1, further comprising at least one forward-facing camera coupled to the handle frame, and wherein instructions stored in the memory, when executed by the processor, cause the processor to obtain classifications of objects in images of an environmental scene captured by the forward-facing camera and, when the classifications include at least one hazardous classification, to at least one of cutoff power supply from the at least one power supply to the at least one electric motor, activate at least one brake coupled to one of the plurality of wheels, or provide an alert.

23. The mobility assistance device of claim 22, further comprising a haptic feedback device in the at least one hand control, and wherein the alert comprises activation of the haptic feedback device.
